(19) United States
(12) Patent Application Publication
(10) Pub. No.: US 2008/0071803 A1
(43) Pub. Date: Mar. 20, 2008

(54) METHODS AND SYSTEMS FOR REAL-TIME CITATION GENERATION

(76) Inventor: Michael L. Boucher, Lafayette, CO (US)

Correspondence Address: BRINKS HOFER GILSON & LIONE, P.O. BOX 10395, CHICAGO, IL, 60610, US

(21) Appl. No.: 11/532,378

(22) Filed: Sep. 15, 2006

(51) Int. Cl. G06F 17/00

(52) U.S. Cl. 707/100

(57) ABSTRACT

Methods, systems, and articles of manufacture consistent with the present invention generate correct citations dynamically, interactively and in real time based on the context in which the citation appears and on certain user preferences. As will be described in more detail below, a user inputs information for a citation and requests the citation generator program to generate a correct citation. The citation generator program generates the citation and inserts it into a document. Further, the citation generator program may format citations by applying stylistic rules to the presentation of the citations, verifying the accuracy of the citations, applying corrections and changes to the citations, and maintaining and updating the citations as the document of which they are a part is edited.

### COPYRIGHT CLAIM

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to managing citations in a document, and more particularly to automated methods and systems for managing citations in an electronic document.

### BACKGROUND OF THE INVENTION

Citations to sources are typically found in printed publications, such as court pleadings, filings with government agencies, articles in journals, law student assignments, articles in legal periodicals and other publications, and the like. These citations typically must conform to specific rules established by the authority to which they are submitted. Common sources of rules include the Bluebook: A Uniform System of Citation, ALWD Citation Manual: A Professional System of Citation, local court rules, requirements for specific publications, and the like.

The citation rules may be quite complex. For example, rule 2.1(f) in the 18th edition of the Bluebook describes which commas must be italicized; rule 5.1(a) describes substantially different treatment for quotations that are 49 words long compared with quotations that are 50 words long; and rule 13.7(c) describes how it interacts with rule 4.1(a) to determine the presentation of a footnote that appears within five footnotes of another footnote to the same source but not within a court filing.

Even within a single system, the rules may be inconsistent from one use to another. For example, the Introduction section in the 18th edition of the Bluebook notes that there are different conventions for writing materials for a court versus using exactly the same materials for a law review article, and the differences are substantial. The third edition of the ALWD manual notes substantial differences between the formats for court filings in Colorado compared with filings in Michigan. The rules also become inconsistent over time. For example, the Preface to the 18th edition of the Bluebook lists two pages of changes from the 17th edition, so writing that conforms to the rules in the 17th edition of the Bluebook may not conform to the 16th or 18th editions.

Much legal writing is done by people who do not have legal training. It is quite common for economists, sociologists, political scientists, and others to write articles for legal journals because their experience in their own field contributes insight to the law that is unavailable by reference only to purely legal sources. However, the complex citation system that is required for this type of writing puts these people at a disadvantage because their lack of legal training makes it especially difficult for them to comprehend and apply the citation rules.

Further, legal citations can be long and it can be both time-consuming and distracting to interrupt the writer's train of thought to formulate and enter a citation.

Therefore, there has long been a need for a simple system to automatically enter and manage citations.

### SUMMARY OF THE INVENTION

Methods, systems, and articles of manufacture consistent with the present invention generate and manage citations in an electronic document interactively and in real time. This may be done, for example, by applying stylistic rules to the presentation of the citations, verifying the accuracy of the citations, applying corrections and changes to the citations, and maintaining and updating the citations as the document of which they are a part is edited. The electronic document, in which the citations are present, may relate to a legal issue, such as a court pleading, however the electronic document is not limited thereto.

Although the illustrative examples described herein refer to legal citations and word processing documents, one having skill in the art will appreciate that methods, systems, and articles of manufacture consistent with the present invention are not limited thereto. For example, the citations may be for non-legal sources and the electronic document may be other than a word processing document, such as an electronic slide presentation or spreadsheet.

A citation generator program (the “program”) is a component of a text-manipulation program, such as a word processor, spreadsheet program, presentation program, and the like. Therefore, a user does not need to switch from the text-manipulation program to the program to utilize the program's functionality. As will be described in more detail below, the program performs a variety of functions, including but not limited to: receiving an inputted reference to a source of information, gathering information used to create a citation for the source, analyzing the context in which the citation will appear, generating a citation of the correct form, entering the citation into a document, maintaining the correctness of the citation as changes occur that affect the proper citation format, and modifying other citations that need to be changed as a result of inserting or modifying a particular citation.

In accordance with methods consistent with the present invention, a method in a data processing system having a program in memory for generating a citation to a source in a document is provided. The method performed by the program comprises the steps of: receiving an input; assigning sematic meaning to the input; determining the source based on the assigned semantic meaning; and generating a citation for the determined source

In accordance with articles of manufacture consistent with the present invention, a tangible computer-readable medium containing instructions that cause a data processing system to perform a method for generating a citation to a source in a document is provided. The method performed by the program comprises the steps of: receiving an input; assigning sematic meaning to the input; determining the source based on the assigned semantic meaning; and generating a citation for the determined source.

In accordance with systems consistent with the present invention, a data processing system for generating a citation to a source in a document is provided. The data processing system comprises: a memory having a program that receives an input, assigns sematic meaning to the input, determines the source based on the assigned semantic meaning, and generates a citation for the determined source; and a processing unit that runs the program

In accordance with systems consistent with the present invention, a data processing system for generating a citation to a source in a document is provided. The data processing system comprises: means for receiving an input, means for assigning semantic meaning to the input, means for determining the source based on the assigned semantic meaning, and means for generating a citation for the determined source

Other apparatus, methods, features and advantages of the present invention will be or will become apparent to one having skill in the art upon examination of the following figures and detailed description. It is intended that all such additional systems, methods, features and advantages be included within this description, be within the scope of the present invention, and be protected by the accompanying drawings.

### BRIEF DESCRIPTION OF THE DRAWINGS

FIG. 1 depicts a block diagram of a data processing system suitable for practicing methods and implementing systems consistent with the present invention, generating a legal citation, and inserting the citation into the document.

FIG. 2 depicts the illustrative word processor program in more detail.

FIG. 3 is a flow diagram illustrating exemplary steps performed by the citation generator program for entering a reference to a source into a document.

FIG. 4 is a block diagram of an illustrative word processor document with several citation types.

FIG. 5 depicts a flow diagram illustrating exemplary steps performed by the citation generator program for entering a reference to a source into a document.

FIG. 6 is a block diagram of a graph node that contains information about an element of a reference to a desired source.

FIG. 7 is a block diagram of a graph built from nodes of the form shown in FIG. 6.

FIG. 8 is a flow diagram illustrating exemplary steps performed by the citation generator program, which may use the graph depicted in FIG. 7, to determine whether the syntax of a reference entered by a writer is consistent with the syntax represented by a graph deicted in FIG. 7.

FIG. 9 depicts an example of how an embodiment of the present invention can apply the processing steps depicted in FIG. 8 to a graph having the form depicted in FIG. 7

FIG. 10 is a block diagram of an illustrative General Reference Table.

FIG. 11 is a block diagram of a class data structure that represents a generic entry in the General Reference Table that is not source-specific.

FIG. 12 is a block diagram of data structures of two classes derived from the class depicted in FIG. 11.

FIG. 13 is a block diagram of a Specific Reference Table that holds information specific to individual citations.

FIG. 14 is a block diagram of a class that represents a generic entry in the Specific Reference Table that is not source-specific.

FIG. 15 is a block diagram of two classes derived from the class in FIG. 14 that can represent an entry for a specific types of source and can be used to build the Specific Reference Table.

FIG. 16 depicts an illustrative table that holds graphs having the form shown in FIG. 7.

FIG. 17 is a flow diagram depicting illustrative steps performed by the citation generator program, which may use a table having the form depicted in FIG. 16, to match a reference entered by a writer to a specific source to which the writer wants to cite.

FIGS. 18A and 18B depict two alternate embodiments of a graph node from which the citation generator program may build a graph having the form depicted in FIG. 19.

FIG. 19 is a block diagram of an illustrative graph that the citation generator program may build from the nodes of FIGS. 18A and 18B.

FIG. 20 is a flow diagram depicting illustrative steps performed by the citation generator program for using a graph having the form of FIG. 19 to generate a correct legal citation.

FIG. 21 depicts an illustrative example of using a graph having the form of FIG. 19 to generate a correct legal citation.

FIG. 22 is a flow diagram that shows illustrative steps performed by the citation generator program to identify the context inwhich a citation appears.

FIG. 23 is a flow diagram depicting illustrative steps performed by the citation generator program for choosing a correct form for a citation.

FIG. 24 is a flow diagram that depicts illustrative steps performed by the citation generator program to update citations in a document after a context change.

FIG. 25 is a flow diagram that shows illustrative steps performed by the word processor for performing citation processing operations.

FIG. 26 is a flow diagram depicting illustrative steps performed by the citation generator program for performing citation processing operations.

### DETAILED DESCRIPTION OF THE INVENTION

Reference will now be made in detail to an implementation in accordance with methods, systems, and articles of manufacture consistent with the present invention as illustrated in the accompanying drawings. The same reference numbers may be used throughout the drawings and the following description to refer to the same or like parts.

Methods, systems, and articles of manufacture consistent with the present invention generate correct citations dynamically, interactively and in real time based on the context in which the citation appears and on certain user preferences. As will be described in more detail below, a user inputs information for a citation and requests the citation generator program to generate a correct citation. The citation generator program generates the citation and inserts it into a document. Further, the citation generator program may format citations by applying stylistic rules to the presentation of the citations, verifying the accuracy of the citations, applying corrections and changes to the citations, and maintaining and updating the citations as the document of which they are a part is edited.

The program generates a citation consistent with one or more standards such as The Bluebook, ALWD Citation Manual, various local court rules, standards established for individual publications such as law review journals and legal publications, and other sources of standards known to those skilled in the art.

As will be described in more detail below, the program may not search for a citation in a document but instead relies on the user to identify a citation. As a result, methods, systems, and articles of manufacture consistent with the present invention do not make these mistakes:
identify an ambiguous phrase as a citation,
miss a citation as a result of shortcomings in the citation identification algorithm,
identify only part of a citation, for example reporting “Washington, Adams & Jefferson v. Hamilton” as a citation to “Adams & Jefferson v. Hamilton,” and
include text that is not part of a citation in a citation; for example, given the phrase, “although it is not binding in Delaware or Washington, Adams & Jefferson v. Hamilton is important case law because . . . ” the program does not extract a citation to the non-existent case “Washington, Adams & Jefferson v. Hamilton.”

The program uses information about the document type, cited source, and context in which the citation appears to generate a new citation that replaces whatever the writer inputs. As will be described in more detail below, this provides beneficial results that are not provided by conventional systems. For example, the program can create a citation based on a quick hint from the writer. For example, “WashCase” is not recognizable as a portion of a citation by conventional systems. However, the program may recognize the inputted text and can turn “WashCase” into “Equipto Div. Aurora Equipment Co. v. Yarmouth, 134 Wash.2d 356, 950 P.2d 451 (Wash., Feb. 5, 1998) (NO. 64863-8, 65053-5).” This is because the program does not require a citation to be entered by the writer. The program uses a variety of approaches to infer the source to which a writer wants to cite and then generates a citation to that source without modifying what the writer wrote.

Further, a writer may use any citation system to enter citations or bits of citations and the program will generate a citation that is appropriate to the current context in the current document. For example, if a writer may cut a citation out of a brief to a Michigan appellate court and paste it into a law review article for the University of Chicago, the program will not use the citation standard done in conformance with the local rules of the Michigan courts and instead generates citations compatible with Chicago's Maroonbook style.

Below are illustrative examples consistent with application of methods, systems, and articles of manufacture consistent with the present invention:

### EXAMPLE 1

A writer wants to cite to Fox Television Stations, Inc. v. FCC, 280 F.3d 1027 (D.C. Cir.2002) and uses Fox as the short citation form in several places in the document. Later, the writer adds a citation to a different case, Fox Television Stations, Inc. v. FCC, 293 F.3d 537 (D.C. Cir.2002). To avoid confusion, the writer now wishes to switch from “Fox” to “Fox I” as the short form for 280 F.3d 1027 and use “Fox II” as the short form for 293 F.3d 537. When the writer modifies the information in the first citation, the program will automatically generate all citations, including citations that are already in the document, with the Fox I short form.

### EXAMPLE 2

In a case brief to a court, a writer correctly cites to Hamdi v. Rumsfeld, 316 F.3d 450 (4th Cir. 2003). The writer later uses that part of the brief in a law review article for which the correct citation format is Hamdi v. Rumsfeld, 316 F.3d 450 (4th Cir. 2003). The program will automatically generate the law review form in the law review document. This is unlike conventional approaches, which could do no better than to make the change as part of a separate citation correction process, and would be unable to handle the presence of both the trial court style and the law review style and would fail to correctly modify the citation.

### EXAMPLE 3

A writer inputs the following sentence and correctly cites to it as follows:
Defendant attended a political rally at which he complained about his military draft status and publicly stated, “If they ever make me carry a rifle the first man I want to get in my sights is LBJ.” Watts v. United States, 394 U.S. 705, 706 (1969).

The writer then adds the following sentence, again correctly cited, ahead of the first sentence:
In Watts v. United States, 394 U.S. 705, 705 (1969), the Court defined the true threat standard it has used to reject many Government attempts to criminalize protected political speech.

The citation in the second sentence, which had been correct before the new sentence was added, should now be changed to a short citation to follow the citation standard. The text should look like this:
In Watts v. United States, 394 U.S. 705, 705 (1969), the Court defined the true threat standard it has used to reject many Government attempts to criminalize protected political speech. Defendant attended a political rally at which he complained about his military draft status and publicly stated, “If they ever make me carry a rifle the first man I want to get in my sights is LBJ.” Id. at 706.

In this example, the fact that the second citation appears in a context in which it is not the first citation to the source affects the stylistic rules for how the second citation must be presented. Because it is no longer the first citation to the source, the second citation must be presented in a short form. Conventional approaches fail to take changes in context into account and therefore could not change the citation on the second sentence from the full “Watts v. United States, 394 U.S. 705, 706 (1969)” to the short “Id. at 706.” Methods, systems, and articles of manufacture consistent with the present invention do take context and changes in context into account and therefore generate the correct citation. Methods, systems, and articles of manufacture consistent with the present invention do not attempt to correct “Watts v. United States, 394 U.S. 705, 706 (1969)”, but instead generate a new citation, “Id. at 706.” without modifying the existing citation that the writer entered.

### EXAMPLE 4

A writer enters:
Sentence 1. <F2>ABC v. DEF, 5 F.3rd 26, 64 (4th Cir., 1999).<F2>

(<F2>in the text above indicates that the writer pressed Function Key 2.)

The program replaces that text with this:
Sentence 1. ABC v. DEF, 5 F.3d 26, 64 (4th Cir. 1999).

Specifically, the program replaces F.3rd with F.3d and deletes the comma after “4th Cir.” This follows the citation standard used for the example.

The writer then adds a new sentence and cites the case correctly:
Sentence 1. ABC v. DEF, 5 F.3d 26, 64 (4th Cir. 1999). Sentence 2. <F2>Id. at 30.<F2>

The program generates a cite with the Id. italicized, but otherwise leaves it alone. Then, the writer switches the two sentences. After a typical cut-paste sequence, the text looks like this:
Sentence 2. Id. at 30. Sentence 1. ABC v. DEF, 5 F.3d 26, 64 (4th Cir. 1999).

After the writer requests the paste operation, the program automatically corrects the text as follows:
Sentence 2. ABC v. DEF, 5 F.3d 26, 30 (4th Cir. 1999). Sentence 1. Id. at 64.

The program replaces “Id. at 30” with the full cite and replaces the full cite with “Id. at 64.”

The writer then adds two more sentences:
Sentence 2. ABC v. DEF, 5 F.3d 26, 30 (4th Cir. 1999). Sentence 1. Id. at 64.
Sentence 3. XYZ, 6 F.3d at 7. Sentence 4. ABC, 5 F.3d at 40.

Then, the writer realizes that the case name is wrong and should be ABCD v. DEF. The writer makes that correction in one of the cites (the example below shows the correction applied to the cite after sentence 2.)
Sentence 2. ABCD v. DEF, 5 F.3d 26, 30 (4th Cir. 1999). Sentence 1. Id. at 64.
Sentence 3. XYZ, 6 F.3d at 7. Sentence 4. ABC, 5 F.3d at 40.

The program automatically generates all of the cites, which has the effect of changing the cite after sentence 4:
Sentence 2. ABCD v. DEF, 5 F.3d 26, 30 (4th Cir. 1999). Sentence 1. Id. at 64.
Sentence 3. XYZ, 6 F.3d at 7. Sentence 4. ABCD, 5 F.3d at 40.

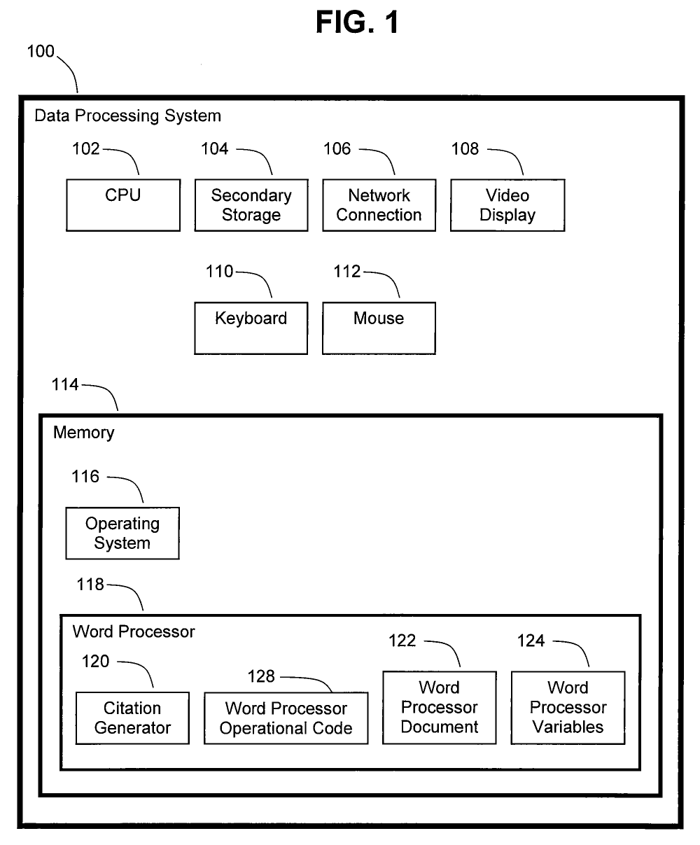

FIG. 1 depicts a block diagram of a data processing system 100 (“the system”) suitable for practicing methods and implementing systems consistent with the present invention. Data processing system 100 comprises a central processing unit (CPU) 102, a memory 104, a secondary storage device 106, a network connection 108, a display device 110, a keyboard 112, and a mouse 114. The memory includes an operating system 116 (e.g., Windows, Solaris, Linux, or the like), a word processor program 1118, and a citation generator program (herein referred to as “citation generator” or “the program”) 120. The software is executed by the CPU 102 under the control of the operating system 116.

The memory allocated to the word processor 118 includes a word processor document 122, blocks of unstructured text that are referred to herein as word processor variables 124, and operational code 128 that operates on data to perform the functions of a word processor. The memory allocated to the word processor also includes the citation generator 120.

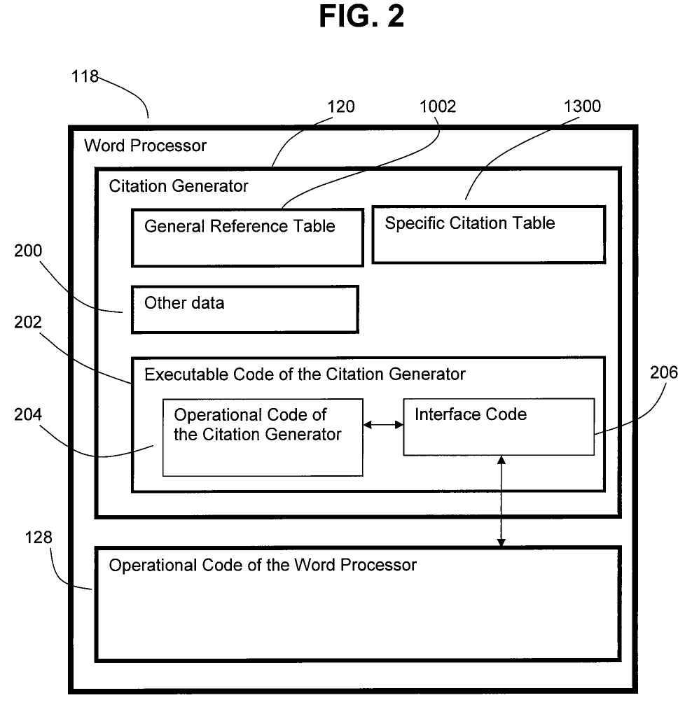

FIG. 2 depicts the word processor 118 in memory 104 in more detail. The memory occupied by the word processor 118 contains word processor operational code 128, which is executable computer software code that performs the functions of a word processor.

The memory occupied by the word processor 118 also contains the citation generator 120. The citation generator 120 is a component of the word processor 118 and may be, for example, a plug-in and the like. The memory occupied by the citation generator program 120 also contains a General Citation Table 1000, a Specific Citation Table 1300, and possibly other data 200. The memory occupied by the citation generator program 120 also contains citation generator executable code 202. The citation generator executable code 202 includes operational code 204 that operates on the data shown and on other data to perform the function of a citation generator. The executable code 202 also contains interface code 206 that interfaces between the operational code 202 of the citation generator 120 and the operational code 128 of the word processor 118.

One skilled in the art will appreciate that each program and module described herein can be a stand-alone program and can reside in memory on a data processing system other than the described system. The program and modules may comprise or may be included in one or more code sections containing instructions for performing their respective operations. While the programs and modules are described as being implemented as software, the present implementation may be implemented as a combination of hardware and software or hardware alone. Also, one having skill in the art will appreciate that the programs and modules may comprise or may be included in a data processing device, which may be a client or a server, communicating with described system.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of system 100 have been described, one skilled in the art will appreciate that a data processing system suitable for use with methods, systems, and articles of manufacture consistent with the present invention may contain additional or different components.

One having skill in the art will appreciate that the system can be implemented in a client-server data processing system. In that case, a program or module can be stored on, for example, the system as a client, while some or all of the steps of the processing of the program or module described below can be carried out on a remote server, which is accessed by the system over a network. The remote server can comprise components similar to those described above with respect to the system, such as a CPU, an I/O, a memory, a secondary storage, and a display device.

Although aspects of the present invention are depicted as being stored in a table, one skilled in the art will appreciate that methods and systems consistent with the present invention may use other data structures. Further, although aspects of the present invention are depicted as being stored in a single data structure, one skilled in the art will appreciate that methods and systems consistent with the present invention may spread the data over multiple data structures, some of which may contain unique information and some of which may contain information that duplicates data in other data structures. Although aspects of the present invention are depicted as being explicitly stored in a data structure, one skilled in the art will appreciate that methods and systems consistent with the present invention may represent certain data implicitly such as one would do consistent with ordinary practice of storing data in a normal form such as third normal form (3NF) or Boyce-Codd Normal Form (BCNF). Also, although aspects of the present invention are depicted as being stored in a single format, one skilled in the art will appreciate that methods and systems consistent with the present invention may store some data in multiple formats in a single or multiple data structures to achieve objectives related to compression, faster access time, facilitation of certain operations, ease of implementation, ease of debugging, or other objectives.

Aspects of the present invention are depicted as being in the same process, but one skilled in the art will appreciate that elements may reside in the same or different threads, fibers, or other ways of organizing code and data within a process. Further, although aspects of the present invention are depicted as interacting through a function call mechanism, one skilled in the art will appreciate that other communication methods are possible including message passing, various mutex or semaphore based systems, or other means known to those with skill in the art. The names of certain elements include words such as “table” that may imply a certain storage form or means of organization for the data therein, but one skilled in the art will readily appreciate that many data structures including linked lists, hash tables, and implicit storage schemes that may not explicitly store the data are within the scope of the present invention.

As will be described in more detail below with reference to the drawings, methods, systems, and articles of manufacture can generate citations from scratch. This is unlike conventional citation systems that correct existing citations.

### Generating Citations

Because the citation generator program generates citations from scratch, it need not start with something recognizable as a citation that can be corrected. For example, consider a document citing Hamdi v. Rumsfeld, 296 F.3d 278 (4th Cir. 2002). If the citation generator program recognizes the user inputting function key 2 (F2) as indicating the beginning and end of a citation, the citation generator program may recognize the user input string <F2>Ham<F2>as indicating that the writer wants a citation to Hamdi v. Rumsfeld, 296 F.3d 278 (4th Cir. 2002).

Conventional systems modify already-entered incorrect citations. For example, a conventional system may convert the citation 296 F3rd 278 to 296 F.3d 278. Therefore, conventional systems require the user to input a citation, which is close to the correct citation, otherwise the inputted citation would not be recognized. Methods, systems, and articles of manufacture consistent with the present invention allow the user to input less information than a citation and enough information to allow the citation generator program to recognize the desired source.

### Dynamic Citation Management

The citation generator program edits citations and then dynamically modifies them as necessary to keep them correct. This is unlike conventional systems that operate statically on a document by correcting a cite and then never addressing the cite again unless the user explicitly asks the conventional system to re-examine the cite or the entire document. The illustrative example below (reproduced from Example 3 above) is used to describe this process.

A writer writes the following sentence, which includes a proper citation:
Defendant attended a political rally at which he complained about his military draft status and publicly stated, “If they ever make me carry a rifle the first man I want to get in my sights is LBJ.” Watts v. United States, 394 U.S. 705, 706 (1969).

The writer then adds the following sentence, again correctly cited, ahead of the first sentence:
In Watts v. United States, 394 U.S. 705, 705 (1969), the Court defined the true threat standard it has used to reject many Government attempts to criminalize protected political speech.

The citation in the first-written sentence, which had been correct before the new sentence was added, should now be changed to a short citation. The corrected text should look like this:
In Watts v. United States, 394 U.S. 705, 705 (1969), the Court defined the true threat standard it has used to reject many Government attempts to criminalize protected political speech. Defendant attended a political rally at which he complained about his military draft status and publicly stated, “If they ever make me carry a rifle the first man I want to get in my sights is LBJ.” Id. at 706.

In the example, the fact that the second citation appears in a context in which it is not the first citation to the source affects the stylistic rules for how the second citation must be presented. Because it is no longer the first citation to the source, the second citation must be presented in a short form. Conventional approaches do not take changes in context into account and therefore cannot change the citation on the second sentence from the full form “Watts v. United States, 394 U.S. 705, 706 (1969)” to the short form “Id. at 706.” Methods, systems, and articles of manufacture consistent with the present invention do take context and changes in context into account and therefore generate the correct citation. Note that the citation generator program does not attempt to correct “Watts v. United States, 394 U.S. 705, 706 (1969)”, but instead generates a completely new citation, “Id. at 706.” without reference to the citation that the user entered.

Further, the citation generator program works in real time by generating citations and performing other functions as the writer creates a document. This is unlike conventional approaches that work by considering a completed document rather than working with the writer as the writer is creating a document.

### Citation Context

Conventional approaches do not consider the context in which a citation appears. Further, some conventional approaches behave differently depending on whether the document in which a citation appears is a court or non-court document. Methods, systems, and articles of manufacture consistent with the present invention overcome these limitations by looking at surrounding citations. For example, given a citation in which the previous citation cited to the same source, the citation generator program automatically generates a short citation (e.g. Id.) instead of a full citation.

The citation generator program also considers elements of context that do not relate to other citations. For example, some rules of citation require that all citations to a given source, after the first citation to that source, must use a short form of citation. However, other rules require that the first citation to a source in any chapter must use a full citation form, even if the source has been cited before in a previous chapter. The citation manager program may consider the presence or absence of intervening chapter breaks as one element of context.

### User Preferences

In many cases, the form of the citation depends on user preferences. For example, the Bluebook lists several acceptable alternate forms for short citations. The citation manager program allows the writer to choose which forms the writer would prefer. For example, if there is a section heading between the current citation and the closest previous citation to the same source, it is acceptable to either use a short citation because of the previous citation or to use a full citation to avoid using short cites that refer to cites in other sections. The citation generator program may take the writer's preferences into account to determine whether to generate a short or long cite form. This can be done, for example, by presenting options on the video display and allowing the writer to input the writer's preferences.

### Marking Cites

The citation manager program allows the writer to mark cites. However, the thing marked need not be a citation. For example, a writer may enter simply <F2>Ham<F2>to indicate that the writer wants a citation to Hamdi v. Rumsfeld, 296 F.3d 278 (4th Cir. 2002).

As will be described in more detail below, the citation generator program provides functionality for: creating a citation, editing a citation, cutting text containing a citation, pasting text containing a citation, and other functionality.

### Creating a Citation in a Document

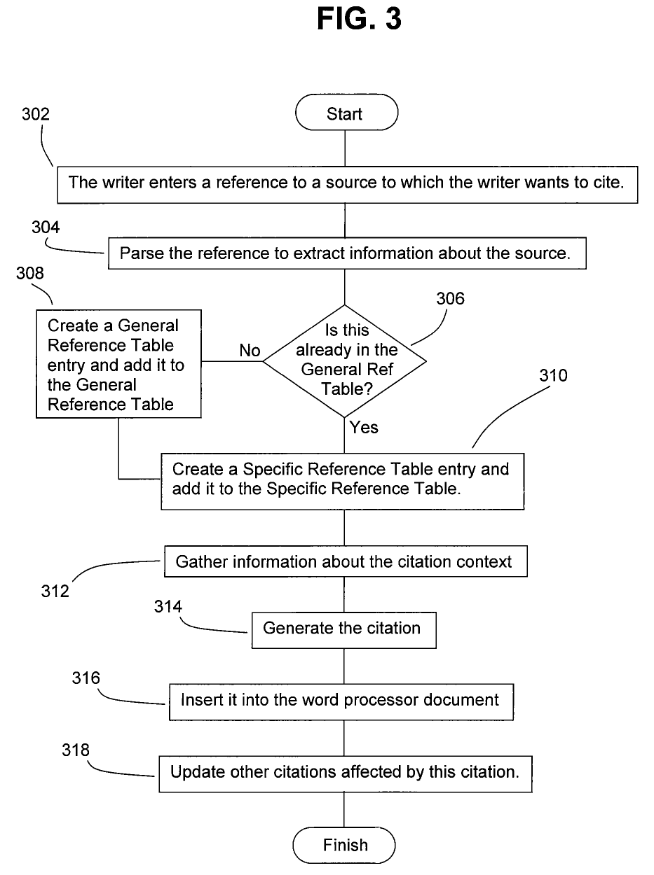

FIG. 3 is a flow diagram illustrating exemplary steps performed by the citation generator program for entering a reference to a source into a word processing document 122, generate a correct legal citation to that source, and insert that citation into the word processing document 122.

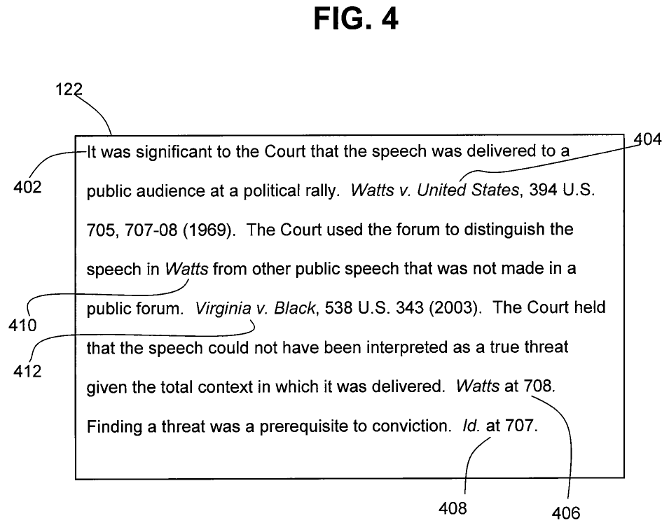

FIG. 4 depicts an illustrative word processor document 122 of the type that may be created by a writer. It may include one or more sentence types including ordinary sentences 402 (e.g., a sentence that includes non-citation text, but may also include a citation), long citations 404 and 412, short citations 406, and Id. citations 408. Ordinary sentences may also contain embedded references 410.

In an example, a long form 404 may be used the first time a source is cited in a unit of a word processor document 122. A unit is a contiguous range of text that, for example, starts with a heading or with the beginning of a document and ends just before the next heading or at the end of the word processor document 122; chapters and sections are illustrative common units. One having skill in the art will appreciate that a unit may have alternative start and end points.

As required by some citation conventions, a short form 406 may be used when a citation to the same source appears earlier in the section in which the short citation is to be used, but the preceding citation is not immediately before the short citation. With reference to the illustrative example in FIG. 4, the short cite 406 is not a long cite because there is already a long cite 404 in this unit. Also, the short cite 406 is not an Id. cite because there is an intervening citation 412, Virginia v. Black, to a different source.

In the illustrative convention, an Id. form 408 is used when the immediately preceding citation 406 refers to the same source.

The sentences and citations may be entered into the word processor document 400 in a variety of ways including, for example, entering the text on a keyboard, cutting it from another source and pasting it into the document, generating the source through some algorithm, other manner, or some combination of the foregoing.

Referring back to FIG. 3, in step 302, the writer enters a reference to a source into the word processor document 122, for example by typing in a text string. A reference can be anything that allows an algorithm to determine the source to which a writer intends to cite. For example, it may be as complete as a full citation, as short as a single character, and the like. A reference need not be text entered by a writer. It could be selected from a menu, chosen by clicking an icon, or indicated indirectly by naming a web page, database, or service that will supply the source. All of the following may be legitimate illustrative references:

| | |
|---|---|
| Watts v. United States, 394 | Long-form citation |
| U.S. Pat. No. 705, 707 (1969) | |
| Watts, 394 U.S. at 707. | Short-form citation |
| Id. at 707. | Id. form citation |
| X | Singlecharacter nickname |

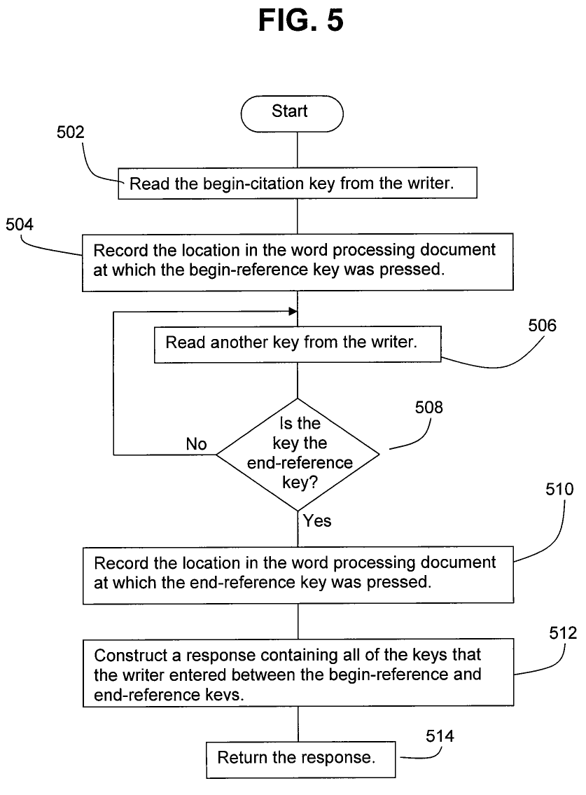

FIG. 5 shows the process of step 202 in more detail. FIG. 5 is a flowchart illustrating how the program enables a writer to enter references to sources into the document, processes the writer's input, and returns the reference that the writer enters.

In step 502, the program receives the writer's input of a key that is defined to indicate the beginning of entering a reference. For example, the writer may input Function Key 2 (F2). This description will illustratively refer to that key as the begin-reference key. There may be several begin-reference keys or there may be only one. For example, there may be a begin-reference key to indicate the beginning of a reference to a case, another for a statute, and so forth.

In step 504, the program records the location in the word processing document of the selection point where the writer presses the begin-reference key. The selection point is the point in the text at which the cursor is located. Then, the program receives input that the writer presses another key (step 506).

The program then decides whether the key pressed in step 506 is a key that is defined to indicate that the writer is done entering a reference (step 508). This description will refer to that key as the end-reference key. The begin-reference key and the end-reference key may be the same or different keys. If the key is not the end-reference key, control flows to step 506 to receive another key input.

If the key is the end-reference key, the program records the location in the word processing document of the selection point where the writer presses the end-reference key (step 510). Then, the program constructs a response containing the characters entered in 506 (step 512) and returns the response constructed in step 512 (step 514).

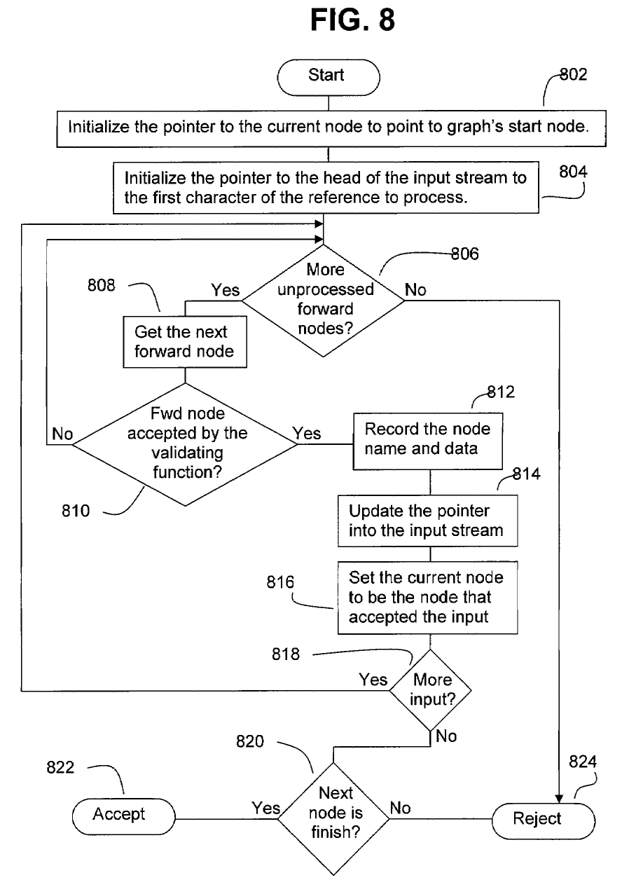

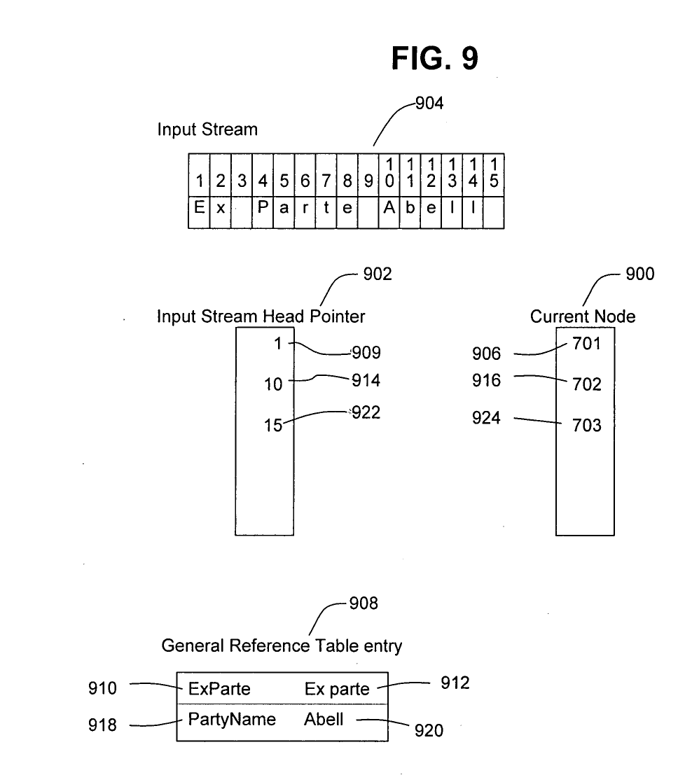

Referring back to FIG. 3, in step 304, the program parses the reference to assign a sematic meaning to the input and to extract information about the source to which the writer wants to cite. This may include both information that the writer explicitly enters as well as information that the program infers such as the type of source to which the writer wants to cite. As will be described below, FIGS. 8 and 9 depict a process by which the program parses and extracts information from a reference.

The information extracted from the reference that is applicable to all citations to a particular source is stored in the General Reference Table 1000; information that may apply to a specific citation is entered into the Specific Reference Table 1300. For example, in a paper that cites to a particular book, all citations to the book will use the same title so the title is considered general information; however, not all citations to the book will use the same page so page number is specific information.

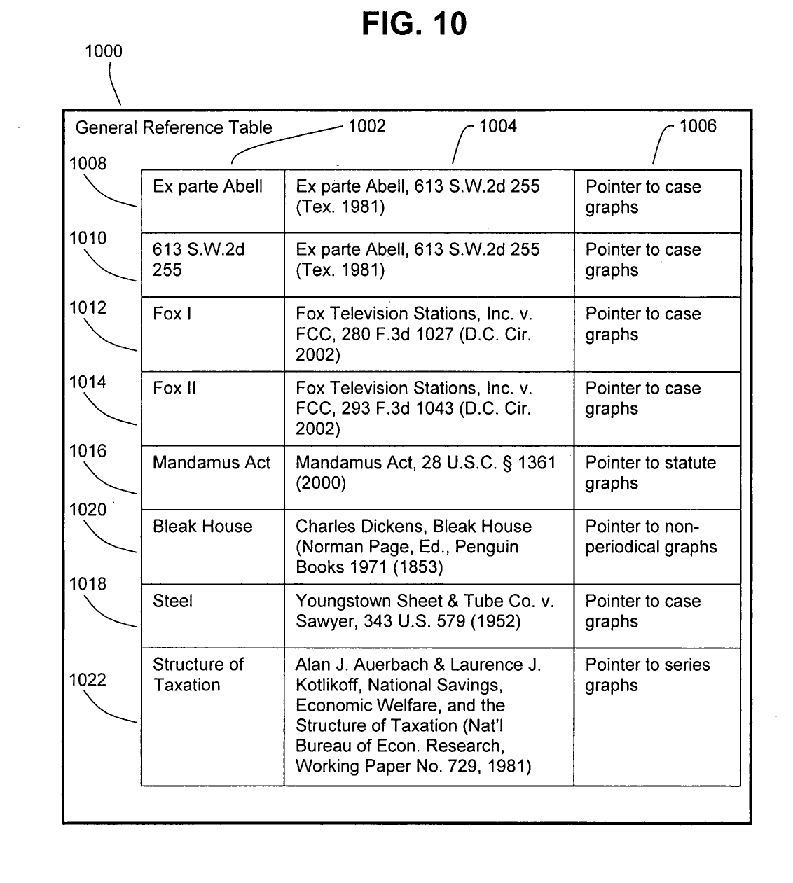

In step 306, the program searches a General Reference Table 1000 to decide whether the source to which the writer referred is in the General Reference Table 1000. The General Reference Table 700 is described in more detail below with reference to FIG. 10. If it is not, control flows along the No branch to step 308, otherwise control flows along the Yes branch to step 310.

In 308, the program creates a General Reference Table 1000 entry for this reference and source, then inserts it into the General Reference Table 1000.

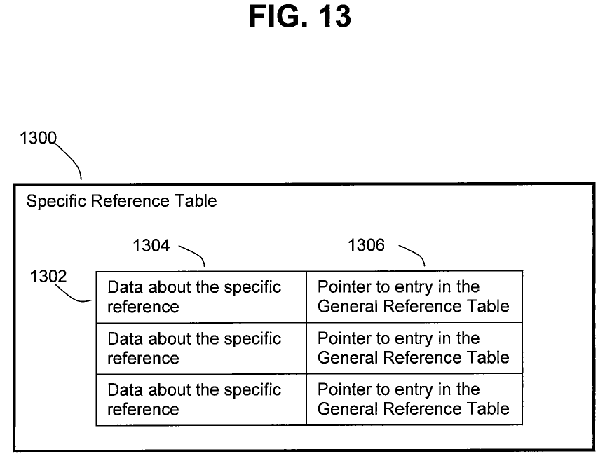

In 310, the program creates a Specific Reference Table 1300 entry for this reference and source, then inserts it into the Specific Reference Table 1300. The Specific Reference Table 1300 holds information specific to a particular citation and is described in more detail below with reference to FIG. 13. For example, all citations to a particular book need not all cite to the same page, so the page number to which a particular citation refers is stored in the Specific Reference Table 1300.

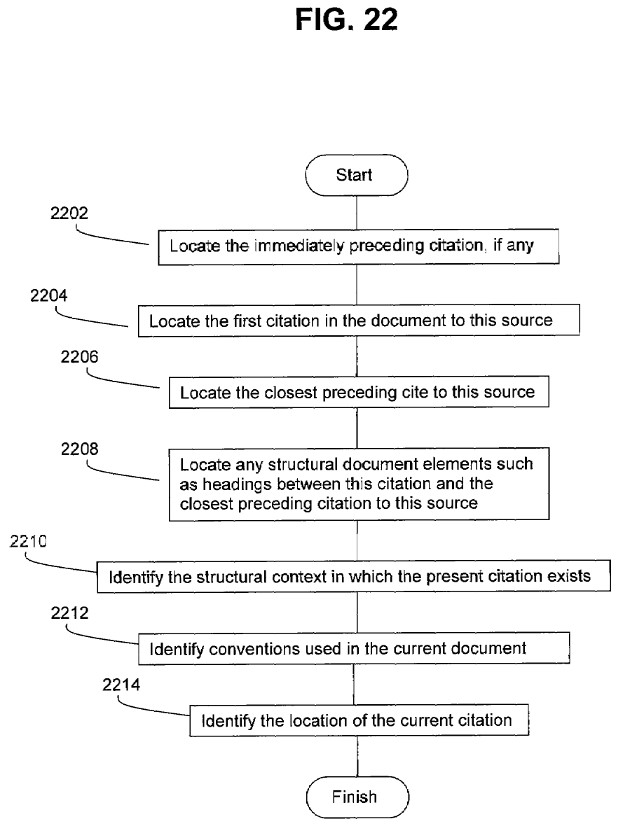

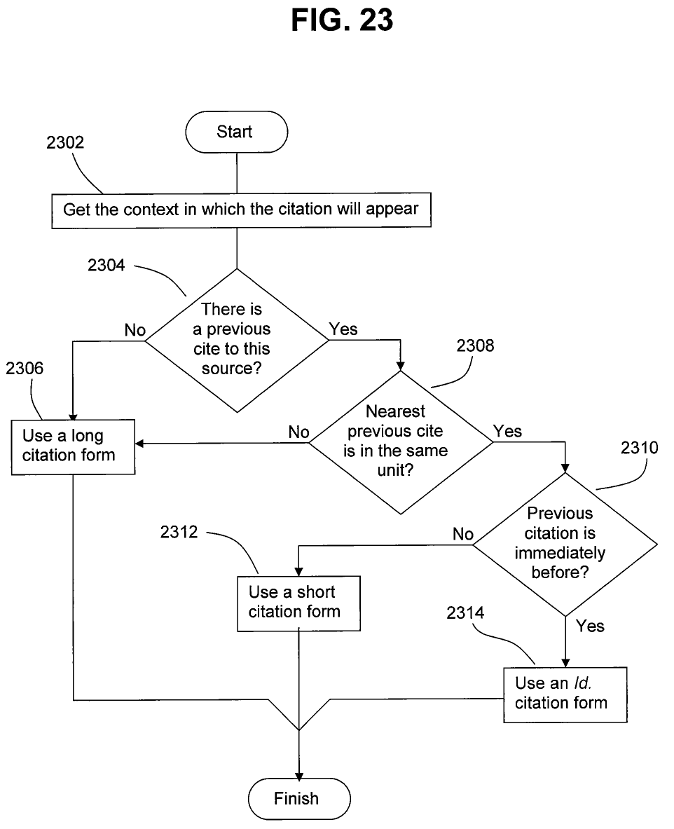

After gathering enough information to create a correct legal citation to the desired source, the program chooses a format for the citation (step 312). The format is determined by the context in which the citation will appear. Context includes information such whether a particular source has been cited earlier in the word processor document 122 and the source to which the immediately-preceding citation refers. Context may also include the placement of headers, chapter and section breaks, and other structural elements of a word processor document 122 relative to the placement of the citation. Context also includes the structural elements of the part of the document in which the citation is to appear such as whether it will appear in body text, a footnote, a table, or some other document structure. As described in more detail below, FIG. 22 depicts an illustrative process by which methods, systems, and articles of manufacture consistent with the present invention may gather information about context. FIG. 23 depicts an illustrative process whereby said methods, systems, and articles of manufacture consistent with the present invention may use context information to choose a citation format. In the illustrative example, there are three citation formats: long, short, and Id.

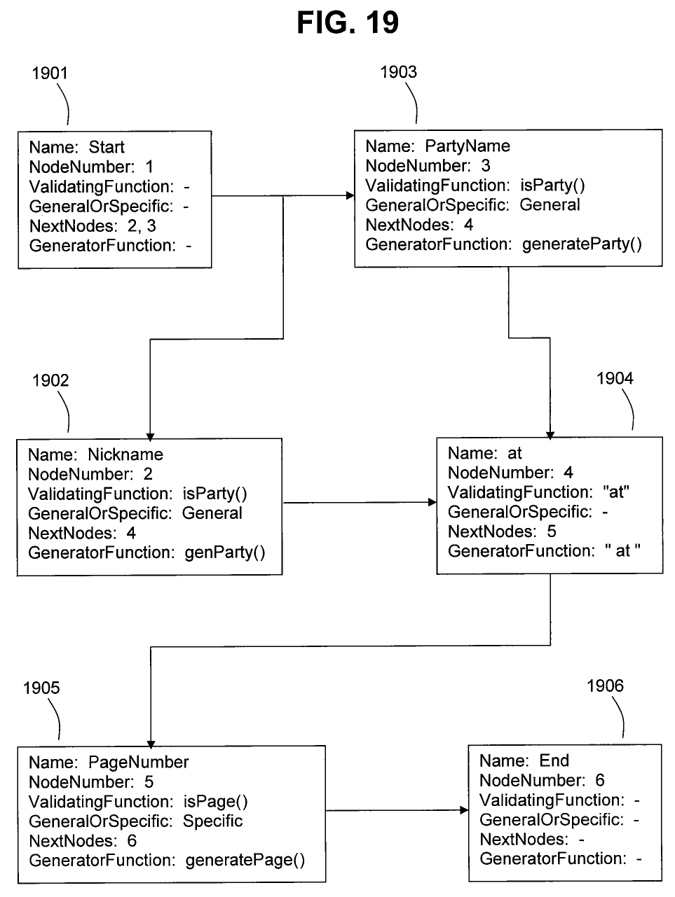

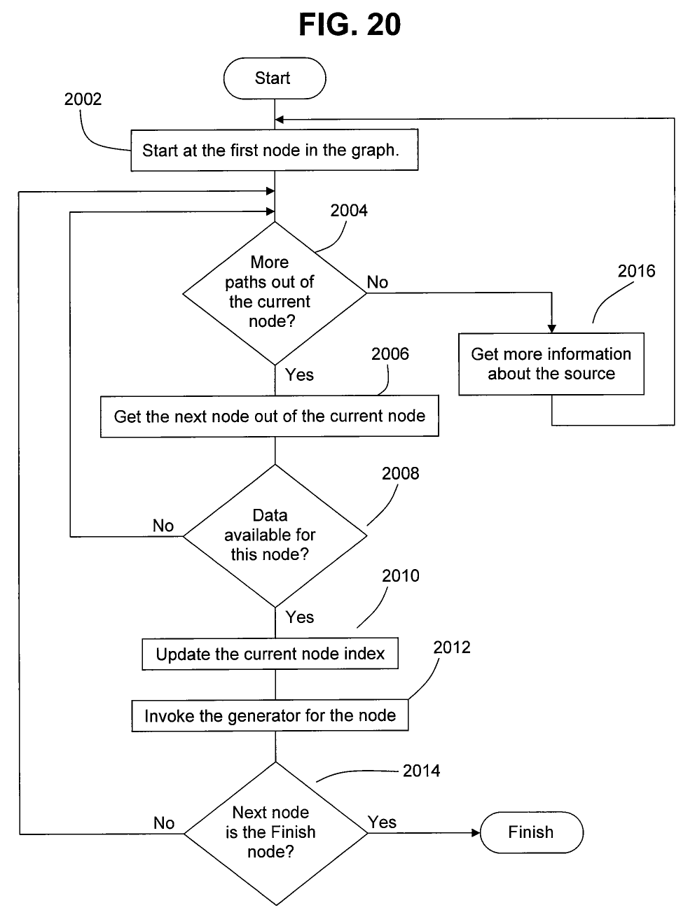

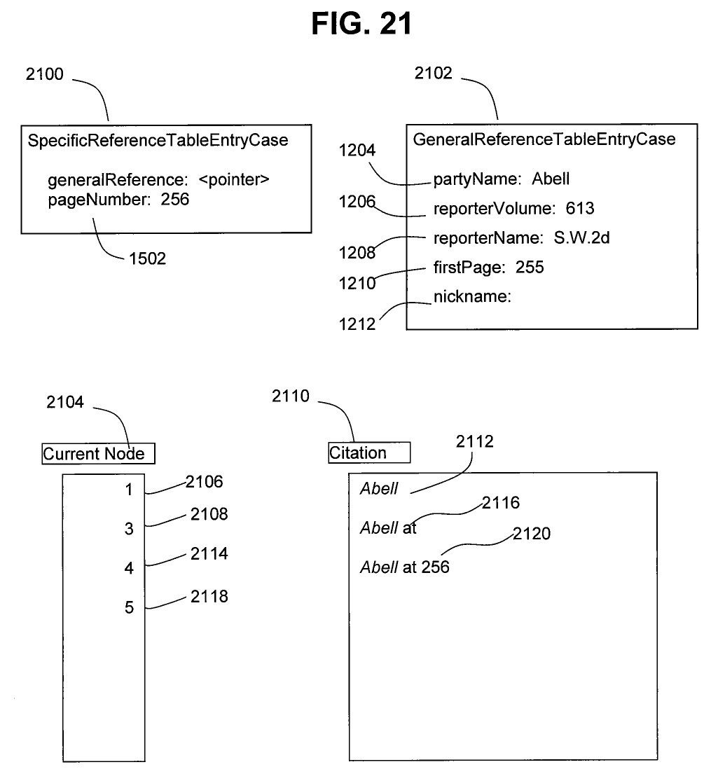

Once a citation format has been chosen, the program generates the citation (step 314). In the preferred embodiment, citations are generated from graphs such as those having the form of FIG. 19. The set of graphs that generate a citation to a particular source appear in the graphTable 1104 field of the General Reference Table 1100 entry for a particular source. The program retrieves the first, second, or third graph in the graphTable 1104 field (corresponding to a long, short, or Id. citation format) and then use the process depicted in FIGS. 20 and 21 to generate the citation. FIGS. 20 and 21 are described in more detail below.

Then, the program replaces the reference that the writer entered with a correct legal citation to the desired source in the word processor document 122 (step 316).

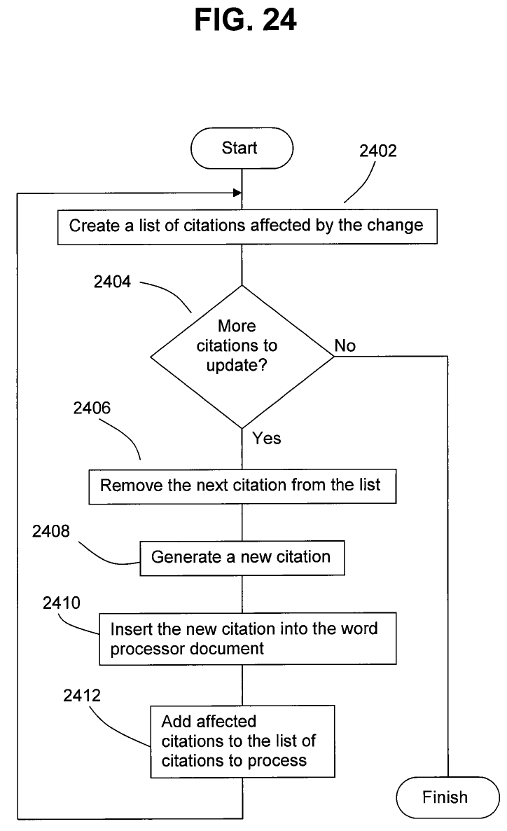

After a citation is added to a word processor document 122, it may be necessary to redo some of the other citations in the document (step 318). For example, if a writer enters a citation to a source immediately ahead of a full citation to the same source, the second citation must be converted to an ‘Id.’ citation. As described in more detail below, FIG. 24 depicts an illustrative process that methods, systems, and articles of manufacture consistent with the present invention can use to update other citations in the document that need to change due to the addition of the new citation.

### Editing a Citation in the Document

A second operation that a writer can perform is to edit a citation that has already been entered. The program does this by editing the citation, updating the appropriate entries in the General Reference Table 1000 and the Specific Reference Table 1300, and then regenerating the affected citations.

A writer can edit a citation by putting the cursor on the citation and adding, deleting, or changing characters in the citation. The result of the edit need not be syntactically correct or even resemble a citation because the program treats the writer's input as a reference and automatically converts it to a citation in correct format.

After the writer has modified the citation, the program treats the modified text as a reference and extracts from the reference information about the source to which the writer wants to cite. FIGS. 8 and 9 depict an illustrative processes for extracting information from a reference and are described in more detail below.

The program uses the information extracted from the reference to update the appropriate entry in the General Reference Table 1000. This is performed using the illustrative process depicted in FIG. 24 to update the citations affected by the change, specifically by regenerating each affected citation from the information in the General Reference Table 1000 and the Specific Reference Table 1300.

### Cutting a Citation from the Document

A third operation that a writer can perform is to cut, from the word processor document 122, text containing a citation. The program affects this by selecting and cutting the text containing the citation or citations, updating the appropriate entries in the General Reference Table 1000 and the Specific Reference Table 1300, then regenerating the affected citations.

The operations of selecting and cutting text from a word processor document 122 may be done in a conventional manner that such operations may typically be done by a word processor 118. Then, the program examines the cut text to find any citations. The program then deletes the corresponding entries in the Specific Reference Table 1300 for those citations using delete operations. Deleting entries from tables is known in the art. Finally, the program applies an algorithm, such as the algorithm depicted in FIG. 24, to update the citations affected by the deletions. FIG. 24 is described in more detail below.

### Pasting a Citation into the Document

A fourth operation that a writer can perform is to paste, into the word processor document 122, text containing one or more citations. The program effects this by pasting the text containing the citation or citations, adding entries in the Specific Reference Table 1300 and, where necessary, the General Reference Table 1000, then regenerating the affected citations.

The operation of pasting text into a word processor document 122 may be performed in a conventional manner that such an operation may typically be done by a word processor 118. Then, the program examines the pasted text to find any citations. The program then creates corresponding entries in the Specific Reference Table 1300 for each new citation. The program also creates new entries in the General Reference Table 1000 for those sources that do not already have such an entry. Then, the program applies an algorithm, such as the algorithm depicted in FIG. 24, to update the citations affected by the deletions, including both the citations pasted into the word processor document 122 by this operation and other citations that are affected by the presence and placement of the new citations. FIG. 24 is described in more detail below.

### Graph Representing a Reference to a Source

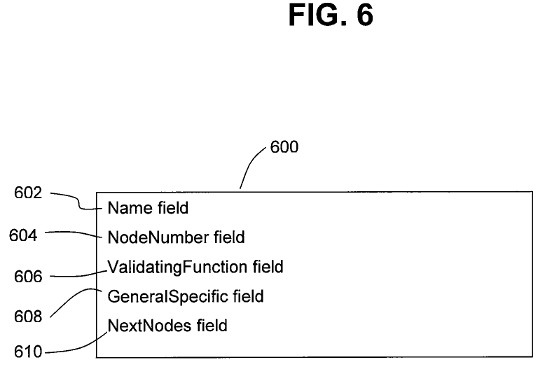

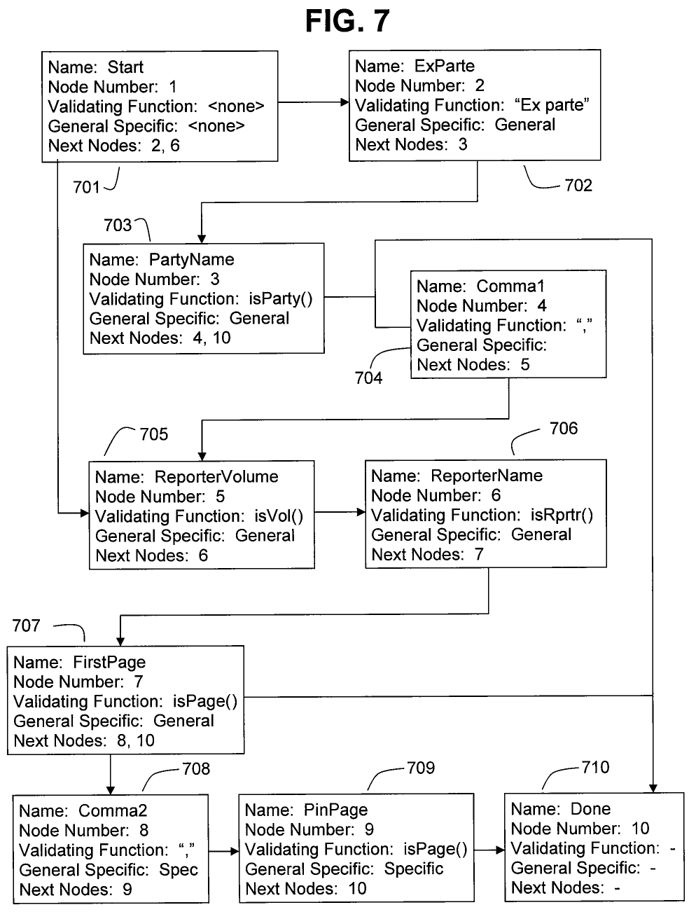

FIGS. 6 and 7 depict a particular data structure that methods, systems, and articles of manufacture consistent with the present invention can use to represent the syntax of a reference to a source. As will be described below, FIG. 6 depicts an abstract form of an illustrative graph node that contains information about an element of a reference to a desired source. An element of a reference may be, for example, a word, punctuation mark, or other constituent component of the reference. FIG. 7 depicts an illustrative graph that the program builds from nodes of the form shown in FIG. 6 that the program may use to store the form of a reference to a desired source.

The illustrative node 600 contains five illustrative data fields. One having skill in the art will appreciate that the node may contain greater, fewer, or alternative data fields. The Name field 602 holds the name of the node. The NodeNumber field 604 contains an integer that uniquely identifies the node within a graph. The ValidatingFunction field 606 contains the function that will be used by the program to determine whether the node will accept a particular string of input. The ValidatingFunction field 606 can contain a constant such as “,”, in which case the node will accept only input that exactly matches the specified constant, or it can name an embodiment of an algorithm that will validate a given input and indicate whether the node accepts the given input or whether it does not.

The GeneralSpecific field 608 indicates whether the datum represented by the node is useful in all cites to this source (general) or valuable to specific cites to this source. For example, the title of a book may be of general value because cites to the book will use the same title. A specific page number in a book is specific information because it may be that only one cite to the book refers to that specific page.

The NextNodes field 610 points to zero or more nodes that immediately follow the current node in the graph.

FIG. 7 depicts an abstract representation of a graph whose nodes have the form depicted in FIG. 6. The graph represents the format of a reference to a source. In the illustrative example, the boxes of FIG. 7 are nodes having the form depicted in FIG. 6. The nodes of FIG. 7 are described in more detail below with reference to FIGS. 8 and 9.

### Using the Graph to Recognize a Reference to a Source

FIG. 8 is a flowchart of illustrative steps performed by the program to recognize a reference to a source using a graph, such as the illustrative graph depicted in FIG. 7. FIG. 8 is described with reference to the illustrative example shown in FIG. 9. FIG. 9 shows an illustrative example of how the program can process the graph in FIG. 7 according to the processing steps depicted in FIG. 8 to process a reference to a source.

In the illustrative example, the following references are considered:
Ex parte Abell
613 S.W.2d 255

In step 802, the program starts processing the graph at node 701 by assigning CurrentNode 900 a value 906 of 701. Then, in step 804, the program initializes the Input Stream Head Pointer 902 by assigning it a value 908 of 1, which is the index of the first character in the Input Stream 904.

There are two unprocessed paths out of node 701, one going to node 702 and the other going to node 705, so control flows from decision box 806 along the Yes path to processing box 808.

In the step 808, the program takes the first path out of node 701, which leads to node 702. The Input Stream Head Pointer 902 has a current value 909 of 1, so at decision box 810, the program considers text starting at character 1 in the Input Stream 904. The text starting at character 1 in the Input Stream 904 is “Ex parte”. The validating function in node 702 accepts the string “Ex parte”, so the program flows from decision box 810 along the Yes path to 812.

In step 812, the program records in the Results List 908 the node name 910 and value 912 of the input that node 702 processed. Then, the program advances the Input Stream Head Pointer 902 into the Input Stream 904 past “Ex parte” (step 814). The index of the first character after “Ex parte” is 10 so the program advances past “Ex parte” by assigning the Input Stream Head Pointer 902 a new current value 914 of 10. Node 702 accepted “Ex parte”, so the program sets the current node to node 702 by assigning CurrentNode 900 a new current value 916 of 702 (step 816).

The Input Stream Head Pointer 902 is not at the end of the Input Stream 904 so the program flows from decision box 818 along the Yes path to step 806 determine whether there are more unprocessed forward nodes. There is an unprocessed path out of node 702 that goes to node 703 so the program flows from decision box 806 to step 808 to get the next forward node.

At step 808, the program takes the first path out of node 702, which goes to node 703. The Input Stream Head Pointer 902 has a current value of 914 of 10, so the program considers text starting at character 10 in the Input Stream 904 (step 810). The text starting at character 10 in the Input Stream 904 is “Abell”. The validating function in node 703 accepts party names and “Abell” is a party name, so the program flows from decision box 810 along the Yes path to step 812.

In step 812, the program records in the Results List 908 the node name 918 and value 920 of the input that node 702 processed. Then, in step 814, the program advances the Input Stream Head Pointer 902 into the Input Stream 904 past “Abell”. The index of the first character after “Abell” is 15 so the program advances past “Abell” by assigning the Input Stream Head Pointer 902 a new current value 922 of 15.

Node 703 accepted “Abell,” so the program, at step 816, sets the current node to node 703 by assigning CurrentNode 900 a new current value 924 of 703. The current value 922 of the Input Stream Head Pointer 902 is at the end of the Input Stream 904 so the program flows from decision box 818 along the No path to step 820 to determine whether the next node is finished. There are two paths out of node 703, one of which is the finish node 708, so control flows from decision box 820 along the Yes path to the Accept box at 822.

In the illustrative example, the “Ex parte Abell” reference does not include information about the reporter, specifically the reporter volume, reporter name, and first page. A writer may optionally supply such information by entering a more complete reference. For example, “Ex parte Abell, 613 S.W.2d 255” would provide the reporter information by traversing the path 700→701→702→703→704→705→706→707→710. Using this path would generate the following Results List 908:

<ExParte, “Ex parte”>
<PartyName, “Abell”>
<Comma, “,”>
<ReporterVolume, “613”>
<ReporterName, “S.W.2d”>
<FirstPage, “255”>

Similarly, if a writer believes that the party name can be derived using only information from a citation to a reporter, the writer may optionally enter only “613 S.W.2d 255”, which will traverse 700→705→706→707→710 and have the following information in the Results List 908:

<ReporterVolume, “613”>
<ReporterName, “S.W.2d”>
<FirstPage, “255”>

The program may then acquire the party name in some other way if the party name is necessary. This may be done, for example, by looking up the party name in a lookup table.

### General Reference Table

FIG. 10 depicts information that may be contained in an illustrative General Reference Table (GRT) 1000. The GRT includes a plurality of rows 1008, each of which represents one record. Each record includes a plurality of columns as described below.

In the illustrative example, the General Reference Table 1000 holds information common to all citations to a particular source. For example, all citations to a particular book may use the same title so the book title goes into the General Reference Table 1000. All citations may not refer to the same page, so the page number to which a particular citation refers does not go into the General Reference Table 1000 in the illustrative example.

The first column 1002 contains references to sources of information to which a writer may want to cite. These references may take a variety of forms including abbreviations, nicknames, short forms, shortcuts, or other forms. The following are illustrative examples:
case name 1008, here “Ex parte Abell”
reporter reference 1010, here “613 S.W.2d 255”
user-assigned nickname 1012 and 1014, here “Fox I” and “Fox II”
name by which the source is commonly known 1016 and 1018, here “Mandamus Act” and “Steel”
title of a book 1020, here “Bleak House”
short form of a longer title 1022, here “Structure of Taxation”

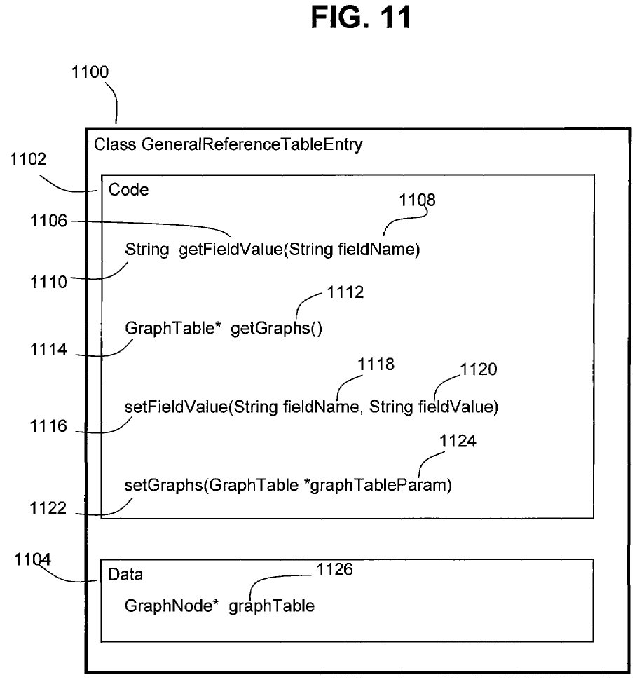

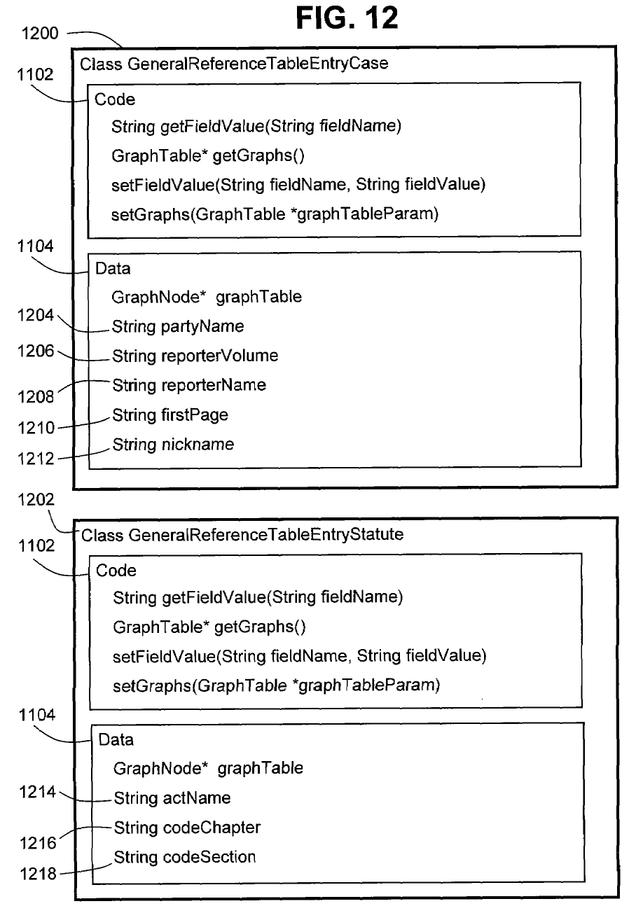

A second column 1004 contains information that the program uses to build a correct citation. One form in which the data in the second column 1004 may be stored is depicted in FIGS. 11 and 12, which are discussed below.

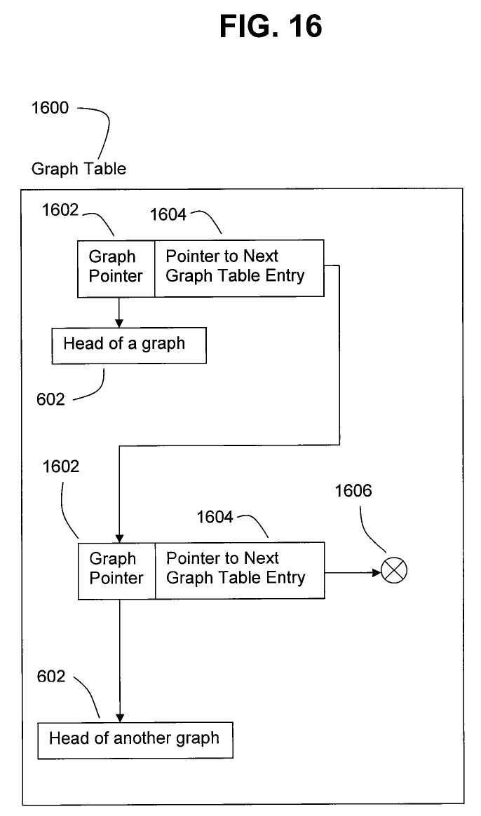

A third column 1006 points to a set of graphs that can be used to put the citation information 1004 into the form of a correct legal citation. One form in which the data in the third column 1006 may be stored is depicted in FIG. 16, which is discussed below.

### Base Class for the General Reference Table

FIG. 11 depicts an illustrative base class that can represent one record or row 1008 of the General Reference Table 1000. The class depicted in FIG. 11 can be readily implemented, for example, in Java, C++, or other object-oriented language.

The GeneralReferenceTableEntry 1100 contains two segments, one for code 1102 and one for data 1104. The code segment 1102 contains a plurality of functions as described below. The data segment 1104 contains a plurality of data structures as described below after the descriptions of the contents of the code segment 1102.

The getFieldValue function 1106 accepts the fieldName parameter 1108 that identifies the name of a field whose value the caller wants to retrieve. getFieldValue 1106 returns the desired field value as a String 1110. The GeneralReferenceTableEntry 1100 base class has no fields in its data segment 1104 so getFieldValue 1106 is ineffective in the base class. However, all of the derived classes, such as those depicted in FIG. 12, use getFieldValue 1106, so it is defined in GeneralReferenceTableEntry 1100 for use by derived classes.

The getGraphs function 1112 returns a table of the graphs that generate valid citations for the source to which this entry in the General Reference Table 1000 refers. The table of graphs returned 1114 by getGraphs 1112 may have the form of the illustrative table of graphs shown in FIG. 16, which is described below. The illustrative table of graphs contains three graphs for each reference. The first graph in the table can generate a full citation, the second can generate a short citation, and the third can generate an Id. citation. Examples of the three citation formats for cases are:
Watts v. United States, 394 U.S. 705, 707 (1969)
Watts, 394 U.S. at 707.
Id. at 707.

A getNextRecord function may return a pointer to the next record in the General Reference Table 1000. The setFieldValue function 1116 sets the value of the field having the name contained in the fieldName parameter 1118 to the value contained in the fieldValue parameter 1120. As with getFieldValue 1106, setFieldValue 1116 is ineffective in the GeneralReferenceTableEntry 1100 base class but useful in derived classes such as those in FIG. 12, so it is defined here for the benefit of derived classes.

The setGraphs function 1122 sets graphTable 1126 to graphTableParam 1124. An addNewRecord function may add the record to which a newRecord structure points to the General Reference Table 1000. The data segment 1104 contains a plurality of records described below. A nextRecord field may point to the next record in the General Reference Table 1000. The graphTable 1126 field points to a table, such as the one in FIG. 16, that contains graphs that can be used to generate correct legal citations.

### Derived Classes for Specific Entries in the General Reference Table

FIG. 12 depicts two illustrative classes derived from the base class 1100 depicted in FIG. 11. The classes depicted in FIG. 12 extend the base class 1100 to make them suitable for storing general reference information about cases 1200 and statutes 1202.

GeneralReferenceTableEntryCase 1200 inherits the code segment 1102 unchanged from GeneralReferenceTableEntry 1100. GeneralReferenceTableEntryCase 1200 adds five new fields to the data segment 1104. Specifically, partyName 1204 stores the name of the party to a case; reporterVolume 1206 stores the volume of the reporter in which the case is reported; reporterName 1208 stores the name of the reporter in which the case is reported; firstPage 1210 stores the first page of said reporter on which the case is reported; and nickname 1212 stores a writer-assigned nickname for the case, if any.

GeneralReferenceTableEntryStatute 1200 inherits the code segment 1102 unchanged from GeneralReferenceTableEntry 1100. GeneralReferenceTableEntryStatute 1200 adds three new fields to the data segment 1104. Specifically, actName 1214 stores the name of the Act; codeChapter 1216 stores the chapter in the U.S. Code at which the statute is codified; and codeSection 1218 stores the section in the named chapter of the U.S. Code at which the statute is codified.

### Specific Reference Table

FIG. 13 depicts an abstract representation of an illustrative Specific Reference Table (SRT) 1300. The SRT contains the part of a citation that is specific to an individual citation. The SRT includes a plurality of rows 1302, each of which represents a specific reference. In the illustrative example, each row includes a plurality of columns. The first illustrative column 1304 includes data about the specific reference. The second illustrative column 1306 includes a pointer to the corresponding entry in the General Reference Table 1000.

The above description of FIG. 10 used the citation “Watts v. United States, 394 U.S. 705, 707 (1969)” as an example citation. That citation refers to a case named Watts v. United States that is reported in volume 395 of the U.S. Reporter starting on page number 705. The material of interest in this particular citation starts on page number 707. The case was decided in 1969. As noted above in the description of FIG. 10, the case name, reporter volume, reporter name, starting page, and year of decision are identical for every citation to this case, so the program places that information into the General Reference Table 1004. This particular citation refers specifically to material that begins on page number 707, which may not be true of every citation to this source, so the reference to page number 707 is not stored in the General Reference Table 1004. The reference to page 707, as well as any other information that may be specific to one particular citation, is placed into the SRT.

### Base Class for the Specific Reference Table

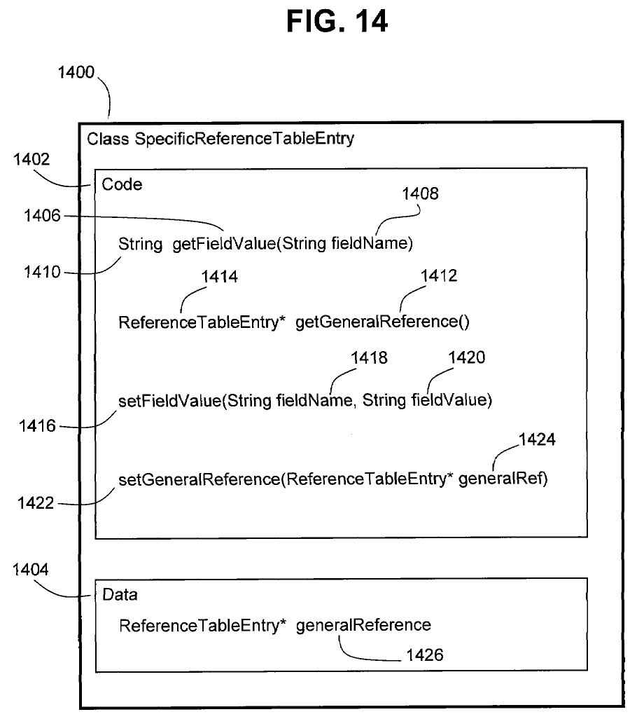

FIG. 14 depicts an illustrative base class that can represent one record or row 1302 of the Specific Reference Table 1300. The class depicted in FIG. 14 can be readily implemented, for example, in Java, C++, or other object-oriented languages.

The SpecificReferenceTableEntry class 1400 includes two segments, one for code 1402 and one for data 1404. The code segment 1402 may include a plurality of functions as described below. The data segment 1404 includes one data structure as described below after the descriptions of the contents of the code segment 1402.

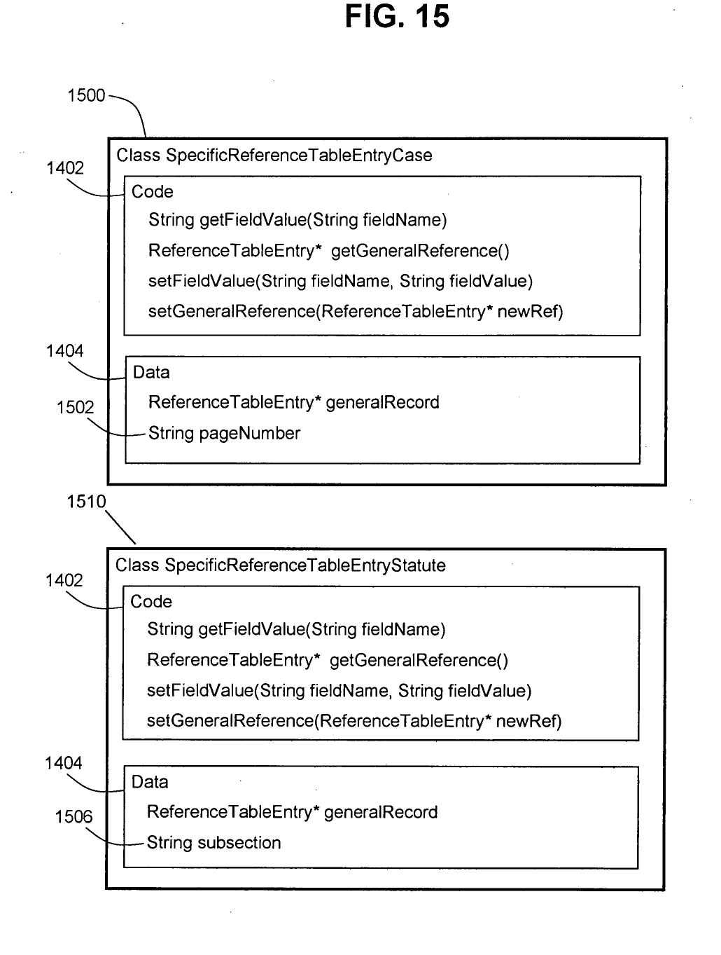

The getFieldValue function 1406 accepts the fieldName parameter 1408 that identifies the name of a field whose value the caller wants to retrieve. getFieldValue 1406 returns the desired field value as a String 1410. The SpecificReferenceTableEntry 1400 base class has no fields in its data segment 1404, so getFieldValue 1406 is ineffective in the illustrative base class. However, the derived classes, such as those depicted in FIG. 15, use getFieldValue 1406, so it is defined in SpecificReferenceTableEntry 1400 for use by derived classes.

The getGeneralReference function 1412 gets a pointer (a ReferenceTableEntry type pointer 1414) to the row 1008 in the General Reference Table 1000 that includes the general information for this specific citation.

The setFieldValue function 1416 sets the value of the field having the name contained in the fieldName parameter 1418 to the value contained in the fieldValue parameter 1420. As with getFieldValue 1406, setFieldValue 1416 is ineffective in the illustrative SpecificReferenceTableEntry 1400 base class but useful in derived classes, such as those in FIG. 15, so it is defined here for the benefit of derived classes.

The setGeneralReference function 1422 sets generalReference 1424 to point to the row 1008 of the General Reference Table 1000 that includes the general information for this specific citation. The data segment 1404 includes the generalReference 1426 field, which points to the row 1008 of the General Reference Table 1000 that includes the general information for this specific citation.

### Derived Classes for the Specific Reference Table

The program may derive classes based on the base class. FIG. 15 depicts two illustrative classes derived from the base class 1400 depicted in FIG. 14. The classes depicted in FIG. 15 extend the base class 1400 to make them suitable for storing general reference information about cases and statutes.

SpecificReferenceTableEntryCase 1510 inherits the code segment 1402 unchanged from SpecificReferenceTableEntry 1400. SpecificReferenceTableEntryCase 1510 adds a new field to the data segment 1404. pageNumber 1502 stores a page number that includes material of particular interest to this citation.

SpecificReferenceTableEntryStatute 1500 inherits the code segment 1402 unchanged from GeneralReferenceTableEntry 1400. SpecificReferenceTableEntryStatute 1500 adds one new field to the data segment 1404. Specifically, subsection 1506 stores the name of a specific subsection of an Act to which this citation refers.

### Using a Table of Graphs to Recognize a Reference

The program may use a table of graphs, such as the illustrative graphs shown in FIG. 7, to recognize a reference to a source. FIG. 16 depicts an illustrative table 1600 that may include one or more graphs, such as graphs having the illustrative form depicted in FIG. 7. Each graph may be stored in a form suitable for use by the program to perform the steps described above with reference to FIG. 8. The table 1600 is a collection of records. Each illustrative record includes a Graph Pointer field 1602 and a Next field 1604. Each Graph Pointer field 1602 points to the head of a graph 602. Each Next field either points to the Graph Pointer field 1602 of the next record or contains an end-of-table indicator 1606.

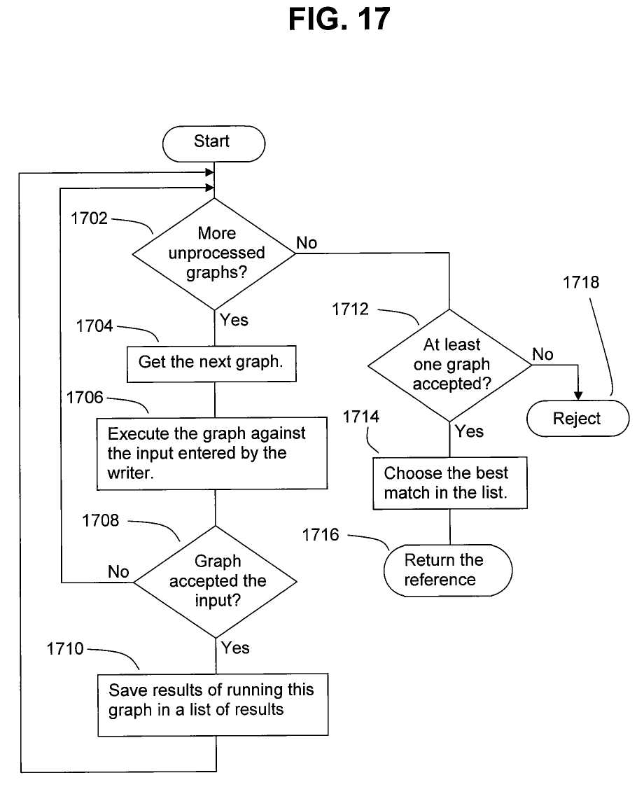

FIG. 17 is a flowchart of illustrative steps performed by the program to use a table of graphs 1600 to recognize a reference to a source. Decision box 1702 is the head of a While loop that ends at step 1710. Decision box 1702 repeats execution of the While loop in FIG. 17 until there are no more graphs on which to execute the algorithm.

In step 1704, the program gets the next graph to use to try to recognize the form of the reference entered by the writer. For example, the program attempts to recognize reference forms that are common in legal writing such as references to court cases, statutes, constitutions, and treaties. Legal writers also commonly use non-legal sources such as books, newspapers, web sites, and so forth. Each of these may have its own reference forms and some of the sources may have multiple reference forms. Each form is represented by a graph. In this step, the program retrieves another graph and uses it to try to recognize the reference form that the writer used.

In step 1706, the program executes the processing steps of FIG. 8 against the graph retrieved in step 1704. Then, the program decides whether executing the graph against the input results in the graph accepting the input or not (step 1708). With respect to FIG. 8, a graph accepts the input if it ends in node 822 and otherwise does not accept the input. If the graph does not accept the input, the program flows along the No branch back to step 1702, otherwise it flows along the Yes path to step 1710.

In step 1710, the program saves the result list 908 in a list that holds the results list 908 for all graphs that accept the input. When there are no more graphs to process, control flows out of decision box 1702 along the No branch to step 1712.

In step 1712, the program decides whether any graph accepted the input. It does this by looking at the contents of the list built at step 1710. If the list built by the program at step 1710 is empty, control flows from decision box 1712 along the No branch to step 1718 to reject the state. If the list built by the program at step 1710 is not empty, control flows along the Yes branch to step 1714.

In step 1714, the program considers all of the matches in the list built at step 1710 and selects the best one. If there is only one, which may be the most common case, it selects that one. If there is more than one, it applies one or more algorithms to determine which one best represents the actual desires of the writer. Such an algorithm may be as simple as asking the writer or arbitrarily choosing the first one, or it may consider and weigh various factors to arrive at its decision. In one embodiment of the present invention, the reference represented by the largest number of nodes is selected. Other algorithms, both deterministic and nondeterministic, may be used.

In step 1716, the program returns the reference chosen in step 1714. As noted in the description of step 1712 above, control flows to reject state step 1718 if none of the known reference forms match the reference entered by the writer.

### Graph for Generating Citations

As described in more detail below, the program may use the General Reference Table 1000, Specific Reference Table 1300, and a graph such as the illustrative graph of FIG. 19 to generate a correct citation.

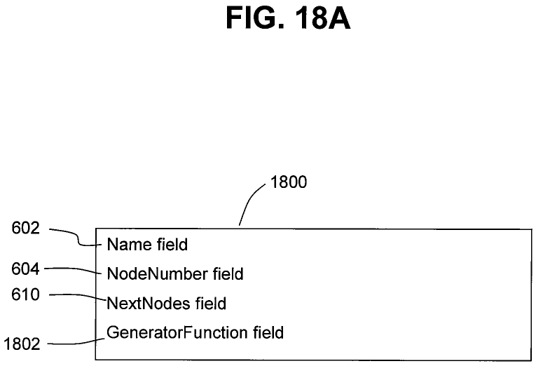

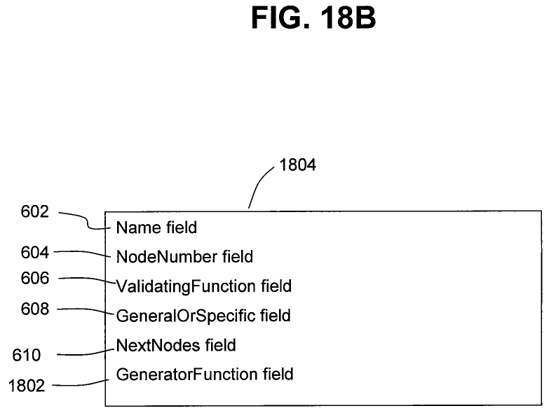

FIGS. 18A and 18B depict alternate illustrative embodiments of a node of a graph that enables citation generation. Both embodiments can be used by the program to build a graph having the form of FIG. 19 to generate a correct citation according to the illustrative method steps described below with reference to FIGS. 20 and 21.

FIG. 18A depicts a node 1800 that may include only the information required to generate a citation to a particular source. In addition to the Name 602, NodeNumber 604, and NextNodes 610 fields taken from the graph node of FIG. 6, node 1800 also contains a GeneratorFunction field 1802. The GeneratorFunction 1802 field names a function that will generate the contents of the node in the correct format for a correct legal citation. The operation of the GeneratorFunction 1802 is described below with reference to FIGS. 20 and 21.

FIG. 18B depicts a node 1804 that may also include the information of the node 600 of FIG. 6 and also the GeneratorFunction 1802 field of the node 1800 of FIG. 18A.

An beneficial characteristic of the node 1800 of FIG. 18A over the node 1804 of FIG. 18B is that it is smaller. A beneficial characteristic of the node 1804 of FIG. 18B over the node 1800 of FIG. 18A is that it contains all information required to parse and generate a particular citation and so only one graph may be required to represent all of the operations that one may want to perform of a citation. FIG. 18B shows the preferred embodiment and is described below with reference to FIGS. 20 and 21.

FIG. 19 depicts an illustrative graph that the program has built from nodes having the form of FIG. 18. The graph of FIG. 19 can be used by the program performing the illustrative process steps of FIG. 20 to generate a correct citation. The reference numerals depicted in FIG. 19 are described with reference to FIGS. 20 and 21.

### Using a Graph to Generate Citations

FIG. 20 is a flow diagram of illustrative method steps performed by the program to generate a correct citation using the General Reference Table 1000, Specific Reference Table 1300, and a graph having the form of FIG. 19. FIG. 21 depicts an example of the process steps depicted in FIG. 20 applied to the graph depicted in FIG. 19. The specific citation to be generated is represented by an entry 2100 in the Specific Reference Table 1300 and a corresponding entry 2102 in the General Reference Table 1000.

In step 2002, the program starts at the first node in the graph 1901 by setting the current value 2106 of Current Node 2104 to 1.

At decision step 2004, there are two unprocessed paths out of the current node 1901, one that leads to node #2 1902 and the other that leads to node #3 1903. Because there are paths left to process, the program flows from step 2004 along the Yes path to step 2006.

In step 2006, the program gets the next node our of the current node. In the illustrative example, the program gets node #2 1902 because it is the first unprocessed path out of the current node 1901. Note that node #2 1902 is named Nickname.

In step 2008, the program determines whether data is available for this node. The program uses the name of node #2 1902 as the fieldName parameter 1108 to call the getFieldValue 1106 function to try to find the value of the Nickname field because Nickname is the name of graph node #2 1902. In this case, the Nickname field 1212 of this entry 2102 in the General Reference Table 1000 is empty, so there is no data available for node #2 1902. Therefore, the program flows along the No branch to step 2004.

In decision step 2004, there is an unprocessed path out of the current node 1901, which is the path to node #3 1903, so the program flows from decision step 2004 along the Yes path to step 2006. In step 2006, the program gets node #3 1903 because it is the next unprocessed path out of the current node 1901. Note that node #3 1903 is named PartyName.

Then, in step 2008, the program uses the name of node #3 1903 as the fieldName parameter 1108 to call the getFieldValue 1106 function to try to find the value of the PartyName field because PartyName is the name of graph node #3 1903. In this case, the PartyName field 1204 of this entry 2102 in the General Reference Table 1000 includes Abell. Therefore, the program flows along the Yes branch to step 2010 to update the current node index. In step 2010, the program updates the current value 2108 of Current Node 2104 to 3 because #3 1903 is the only path out of #1 1901 that has data to display.

In step 2012, the program invokes the function named in the GeneratorFunction field of node #3 1903; for node #3 1903, the value of the GeneratorFunction field is generateParty( ). generateParty( ) writes the value of the node (“Abell”) in italic font to the current value 2112 of Citation 2110.

In step 2014, the program decides whether the next node is the Finish node. In the example, the next node after node #3 1903 is node #4 1904, so the program flows along the No path to step 2004. In step 2004, there is an unprocessed path out of the current node 1903, which is the path to node #4 1904, so the program flows from step 2004 along the Yes path to step 2006. In step 2006, the program gets node #4 1904 because it is the next unprocessed path out of the current node 1903.

Then, in step 2008, the value for the node is a constant “at ”, so the program flows along the Yes branch to step 2010. In step 2010, the program updates the current value 2110 of Current Node 2104 to 4 because #4 1904 is the only path out of #3 1903. In step 2012, the program invokes the generator for the node by generating a constant “at ”, appending it to the current value 2112 of Citation 2110, and setting the resulting string as the new current value 2116 of Citation 2110.

In step 2014, the program decides whether the next node is the Finish node. In the example, the next node after node #4 1904 is node #5 1905, so the program flows along the No path to step 2004. In step 2004, the program determines that there is an unprocessed path out of the current node 1904, which is the path to node #5 1905, so the program flows from step 2004 along the Yes path to step 2006. In step 2006, the program gets node #5 1905 because it is the next unprocessed path out of the current node 1904.

Then, in step 2008, the program uses the name of node #5 1905 as the fieldName parameter 1108 to call the getFieldValue 1106 function to try to find the value of the Page Number field because Page Number is the name of graph node #5 1905. In this case, the pageNumber field 1502 of this entry 2100 in the Specific Reference Table 1300 contains 256. Therefore, the program flows along the Yes branch to step 2010. In step 2010, the program updates the current value 2118 of Current Node 2104 to 5 because #5 1905 is the only path out of #4 1904.

In step 2012, the program invokes the function named in the GeneratorFunction field of node #5 1905, which is generatePage( ). generatepage( ) writes the value of the node (“256”) to the current value 2120 of Citation 2110. In step 2014, the program decides whether the next node is the Finish node. The next node after node #5 1905 is node #6 1906, so the program flows along the Yes path to step 2018. Step 2018 is the Finish box, so the processing steps terminate. The current value 2120 of Citation 2110 is “Abell at 256”, which is the correct legal citation short format for this case.

### Identifying Elements of Context

The program may gather information from various sources to determine the context of the citation. For example, the program may obtain information that the writer enters as part of the citation, other information that the writer inputs, files, databases, web pages, and other sources. The program may also determine the context in which the citation appears, for example, according to the type of document; whether a citation to the current source has been cited in other places in the document; structural elements such as headers or other citations that appear between the current citation and other citations to the same source; and other factors.

FIG. 22 is a flow diagram that shows illustrative steps performed by the program to identify the context in which a given citation appears. The program can use context information to decide on the correct citation format to use for a particular citation.

In step 2202, the program locates the immediately preceding citation, if any. The preceding citation may be to the source to which the current citation cites or to another source. This will help the program determine whether to present the current citation as an Id. citation, for example.

In step 2204, the program locates the first citation to this source in the document. The first citation to a given source may be the current citation. This will help the program determine whether to present the current citation as a full citation or a partial citation.

In step 2206, the program locates the closest preceding cite to the current source. This will help determine whether to present the current citation as a full citation.

In step 2208, the program locates any structural document elements between this citation and the citation identified in step 2206. A structural element may be, for example, a header, footnote, or other element that can affect the presentation of a citation. This will help determine if structural factors override the presentation format that would otherwise be used. For example, one might use a short citation if the current citation cites to a source that has previously been cited. However, if there is a heading between the current citation and the most recent citation to the same source then local citation rules may require that the current citation be presented as a full citation.

In step 2210, the program identifies the structural context in which the current citation exists. The current citation may exist in the main text of a document, a footnote, a table, or other structural contexts.

Then, in step 2212, the program identifies conventions used or desired in the current document. For example, in citations to cases, the case names may be either italicized or underlined but they must be consistent throughout the document. The program may look at previous citations, user preferences, configuration files, consults web services, and otherwise figure out what conventions are applicable to the current citation and how to correctly apply the convention.

In step 2214, the program identifies the location of the current citation. The location may be identified in terms of the index of the page, paragraph, footnote, starting character, or other values. This is useful in determining the distance between one citation and another, which in turn may be used to apply rules in some citation systems. For example, Bluebook Rule 10.9(a) states that a particular form may be used if there is a citation to the same source in at least one of the previous five footnotes. The information gathered in this step will help the program determine the correct citation form for a citation that is covered by such a rule.

### Choosing a Citation Form

FIG. 23 is a flowchart depicting illustrative steps performed by the program for choosing the correct form for a citation. Three illustrative citation forms are discussed below: long, short, and Id. All three forms are depicted in FIG. 4.

In step 2302, the program uses the process steps described with reference to FIG. 22 to get the context in which the citation will appear. In step 2304, the program uses the information from step 2302 to decide whether there is a previous citation to the source to which the current citation cites. If there is no previous citation then the program flows along the No branch to step 2306 to use a long citation form, otherwise it flows along the Yes branch to step 2308 to determine which shorter citation form to use.

In the program determines that there was not a previous citation, then the program uses the long-form citation (step 2306). Otherwise, in step 2308, the program uses the information from step 2302 to decide whether the nearest previous citation is in the same unit (e.g., chapter or section) as the current citation. If it is not, the program flows along the No branch to step 2306 to use the long citation form, otherwise the program flows along the Yes branch to step 2310.

In step 2310, the program decides whether the nearest previous citation examined in step 2308 immediately precedes the current citation. If not, the program flows along the No branch to step 2312 to use the short-form citation, otherwise the program flows along the Yes branch to step 2314 to use the Id. form citation.

In step 2318, the program returns the decision from step 2306, 2312, or 2314.

### Updating Citations in a Document After a Change in Context

FIG. 24 is a flow diagram that depicts illustrative steps performed by the program to update citations in the word processor document 122 after a context change. A context change is a change in the word processor document 122 that may cause the format of a citation to change. Illustrative examples include changing the word processor document 122 by cutting a citation, pasting a citation, altering a citation, adding a header or section break, and the like. Context changes may also occur as a result of a writer changing citation rules, for example by switching from the rules used by the University of Chicago Law Review to the rules used by the Journal of High Technology and Telecommunications Law. The foregoing list is not exhaustive and merely illustrates a few of the many possibilities for context changes.

In step 2402, the program creates a list of citations that are affected by the change in context. The rules for determining the list of affected citations may vary with the citation format rules in effect at the time of the change, the type of change, user preferences, and other factors, so it is not possible to completely specify an algorithm for determining the minimal set of citations that may need to be changed. If no such algorithm can reliably be determined, the program may put all of the citations in a document into this list and regenerate all of them in step 2408; those that must be changed will be generated in their new and correct form while those that do not need to change will be generated as-is.

In step 2404, the program determines whether there are more citations in the list created in step 2402. If there are, the program flows along the Yes branch to step 2406 to remove the next citation from the list, otherwise the algorithm is done and the program flows along the No branch to finish.

In step 2406, the program removes the next citation from the list of citations to regenerate the citation that was created in step 2402. In 2408, the program regenerates the citation. In step 2410, the program replaces the old form of the citation with the new form of the citation in the word processor document 122.

In step 2412, the program determines which citations may be affected by the change in context wrought by inserting the new citation into the word processor document 122. Then, the program adds those changes to the list created in step 2402.

### Citation Processing Operations Initiated by the Word Processor

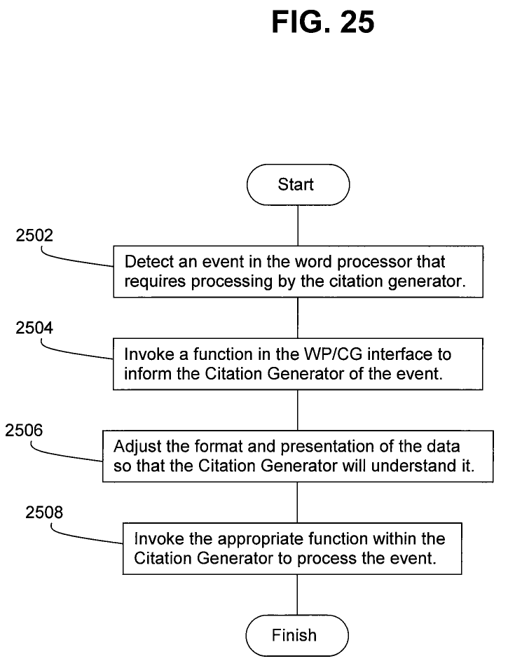

FIG. 25 is a flowchart that shows illustrative steps performed by the word processor 118 for performing citation processing operations in combination with the citation generator program 120. In step 2502, the word processor detects an event or that requires processing by the citation generator program 120. The event may be, for example, certain key presses, a mouse click on a toolbar icon controlled by the citation generator 120, or something else. When an event occurs in the word processor 118 that requires a response from the citation generator 120, the word processor accepts the event.

In step 2504, the operational code 128 of the word processor 118 calls a function in the interface code 206 so that it can activate the appropriate elements within the citation generator 120.

In step 2506, the interface code 206 makes adjustments in the form or presentation of the data to be passed from the operational code 128 of the word processor to the operational code 204 of the citation generator 120. Such adjustments may be conversion from one size of integer to another, ASCII to/from UNICODE, or other transformations.

In step 2508, the interface code 206 invokes the appropriate function in the operational code 206 of the citation generator 120.

### Citation Processing Operations Initiated by the Citation Generator Program

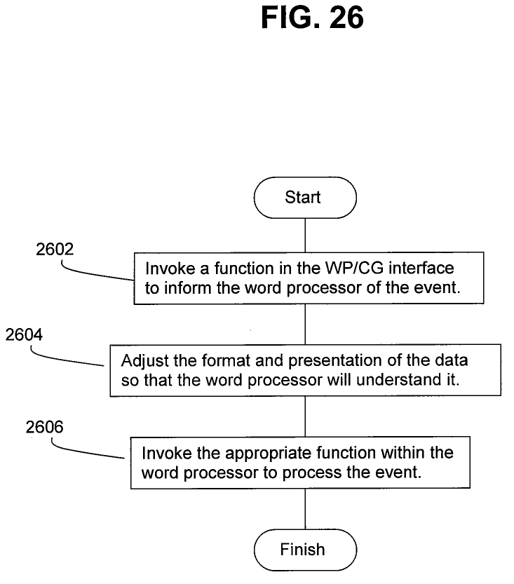

FIG. 26 is a flowchart depicting illustrative steps performed by the citation generator program 120 for performing citation processing operations in combination with the word processor 118. In the illustrative example, the program 120 needs a service from the word processor 118. Such services may be, for example, finding, inserting, deleting, or formatting text in the word processor document 122, and the like.

When the program 120 needs a service from the word processor 118, the control flows to step 2602. In step 2602, the operational code 128 of the word processor 118 calls a function in the interface code 206 so that it can activate the appropriate elements within the operational code 128 of the word processor 118. In step 2604, the interface code 206 makes any necessary adjustments in the form or presentation of the data to be passed from the operational code 204 of the citation generator 120 to the operational code 128 of the word processor 118. Such adjustments may be conversion from one size of integer to another, ASCII to/from UNICODE, and the like.

In step 2606, the interface code 206 invokes the appropriate function in the operational code 128 of the word processor 118.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

1-28. (canceled)

29. A product comprising:
a computer readable medium; and
instructions stored on the medium operable to cause a processor to:
identify in a document a first citation in a first citation form to a source;
determine a document context affecting the first citation;
select a citation generation representation based on the document context;
process the citation generation representation to generate a different second citation form referring to the source; and
replace the first citation form with the different second citation form in the document.

30. The product of claim 29, where:
the document context comprises presence of a second citation in the document.

31. The product of claim 29, where:
the document context comprises a citation ruleset change applicable to the first citation.

32. The product of claim 29, where the document context comprises footnote placement information for the citation, body text placement information for the citation, or both.

33. The product of claim 29, where the document context comprises section break information relative to the first citation.

34. The product of claim 29, where the document context comprises header placement information, chapter break information, or both.

35. The product of claim 29, where the different second citation form comprises a short citation form.

36. The product of claim 29, where the different second citation form comprises a long citation form.

37. The product of claim 29, where the different second citation form comprises an ‘Id.’ citation form.

38. A product comprising:
a computer readable medium; and
instructions stored on the medium operable to cause a processor to:
identify in a document a first citation in a first citation form to a source;
determine a context change that affects the first citation;
select a citation generation representation based on the context change;
process the citation generation representation to generate a different second citation form referring to the source; and
replace the first citation form with the different second citation form in the document.

39. The product of claim 38, where the context change comprises:
an insertion into the document of a second citation.

40. The product of claim 38, where the context change comprises:
a change of a citation ruleset applicable to the first citation.

41. The product of claim 38, where the context change comprises:
a deletion of a second citation.

42. The product of claim 38, where the context change comprises:
a cut operation cutting text from a first location in the document; and
a paste operation inserting the text into the document at a second location different than the first location.

43. The product of claim 42, where the text comprises the first citation.

44. A product comprising:
a computer readable medium; and
instructions stored on the medium operable to cause a processor to:
identify in a document a first citation in a first citation form to a source;
establish a general reference table comprising a general reference table entry for the source, the general reference table entry specifying a set of representations for generating correct citations to the source;
determine a context change that affects the first citation;
choose a second citation form for the first citation to the source based on the context change;
identify a specific citation generation representation from the set of representations based on the second citation form
process the specific citation generation representation to generate the second citation form referring to the source; and
replace the first citation form with the second citation form in the document.

45. The product of claim 44, where the instructions stored on the medium are further operable to cause the processor to:
establish a specific reference table comprising a specific reference table entry for the source, the specific reference table entry comprising citation specific data for the first citation, and where the instructions are further operable to process the specific reference table entry to generate the second citation.

46. the product of claim 45, where the citation specific data comprises a page number.

47. The product of claim 44, where the context change comprises:
an insertion into the document of a second citation.

48. The product of claim 44, where the context change comprises:
a change of a citation ruleset applicable to the first citation.

49. The product of claim 44, where the context change comprises:
a deletion of a second citation from the document.

50. The product of claim 44, where the context change comprises:
a cut operation cutting text from a first location in the document; and
a paste operation inserting the text into the document at a second location different than the first location.

51. A method comprising:
identifying in a document a first citation in a first citation form to a source;
determining a document context affecting the first citation;
selecting a citation generation representation based on the document context;
processing the citation generation representation to generate a different second citation form referring to the source; and
replacing the first citation form with the different second citation form in the document.

52. The method of claim 51, where determining comprises:
determining presence of a second citation in the document.

53. The method of claim 51, where determining comprises:
determining a citation ruleset change applicable to the first citation.

54. The method of claim 51, where determining comprises:
determining footnote placement information for the citation, body text placement information for the citation, or both.

55. The method of claim 51, where determining comprises:
determining section break information relative to the citation.

56. The method of claim 51, where selecting comprises:
selecting between any combination of a short citation form citation generation representation, a long citation form generation representation, and an ‘Id.’ citation form generation representation.
